(19) United States
(12) Patent Application Publication
(10) Pub. No.: US 2004/0135815 A1
(43) Pub. Date: Jul. 15, 2004

(54) Method and apparatus for image metadata entry

(75) Inventors: Cameron Bolitho Browne, Auchenflower (AU); Craig Matthew Brown, Lane Cove (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/734,222

(22) Filed: Dec. 15, 2003

(30) Foreign Application Priority Data
Dec. 16, 2002 (AU) 2002953384

(51) Int. Cl. G09G 5/00

(52) U.S. Cl. 345/810

(57) ABSTRACT

An intuitive graphical user interface (100) for classifying and searching on a plurality of digital images is disclosed. Multiple simultaneous metadata associations and compound searches may be performed, using disclosed methods. Such operations may be performed using simple user actions, which will be familiar to inexperienced or casual computer users who typically want to perform such operations on digital images without a commitment to learning new software or operating paradigms. Metadata is associated with digital images by selecting iconic or thumbnail representations of the images (e.g., 107) and dragging the iconic or thumbnail representations to a destination point to either create a new association for a collection of images or to associate a pre-existing metadata item with the images.

### FIELD OF THE INVENTION

The present invention relates generally to graphical processing and, in particular, to a method and apparatus for associating metadata with a plurality of digital images using a graphical user interface. The present invention also relates to a computer program product including a computer readable medium having recorded thereon a computer program for associating metadata with a plurality of digital images using a graphical user interface.

### BACKGROUND

Digital photography has become increasingly popular in recent times. One reason for the popularity of digital photography is that digital photographs do not require traditional development, with the associated cost and inconvenience. Such digital photographs can be produced and edited easily using readily available digital image software applications. Further, in contrast to traditional photographs, digital photographs are available for viewing and/or use almost immediately, upon the reading of an associated film diskette, by a personal computer (PC), or display device.

As a result of the above, together with the ever-increasing use of digital images on the Internet, large databases of digital images are being assembled for both personal and commercial use. As with conventional photography, the need to annotate and catalogue the ever-increasing number of digital images is of paramount importance in order to allow ease of access and use.

One method of facilitating the annotation of digital images is to generate “metadata” with the image. Metadata is information about the content of digital images or even video. For example, an image depicting a beach scene can include a short textual description such as “a picture of a beach”, the name of a person in the image or a date and time that the image was captured. Many Internet image search sites search on metadata content descriptions to locate digital images for display.

Some digital cameras automatically generate metadata in the form of a date and time, which is generally included in the file name of a digital image when the image is stored and/or displayed (e.g. 12Nov_{—}1.jpg). However, the automatically generated date and time says nothing about the content and/or event depicted by the digital image and therefore provides only limited assistance in annotating, cataloguing and searching for the digital image.

Conventionally, a text entry method of generating metadata for digital images has been used to annotate large numbers of digital images. Such a method requires a person to sort through a database of digital images, using a computer. The user must then store a short textual label with each image, indicating a subject and/or an event depicted by the corresponding digital image. However, the above conventional method is very labour intensive and thus time consuming. As a result, the sorting and labelling of digital images is often neglected due to the time required to individually process voluminous images. The photographer therefore runs a risk of accumulating a growing number of images, many of which are not readily accessible because of the absence of a convenient method of labelling.

In view of the above, efficient methods for classifying such large numbers of images is becoming increasingly essential.

One known method for classifying digital images utilises a hierarchical structure similar to the hierarchical directory or folder structure used by the operating system of most conventional computers. Such a hierarchical structure is used for classifying digital images at a fundamental level by creating a tree of aptly named directories or folders and moving the images to the appropriate target destinations. However, such a process is repetitive and laborious, since the process typically involves viewing each image and then either copying or moving the respective image to the relevant directory or folder.

A further disadvantage of the above classification method is that directory names are necessarily brief and not very descriptive. In addition, there is a problem in cross-referencing images, which are classified into more than one category. For example, if an image is to be classified into more than one category, then multiple copies of the image must be made to each of a number of relevant folders or directories.

The disadvantages of the above classification method have resulted in various other methods being proposed in order to make the process of classifying and storing digital images easier and more efficient. One such method stores collections of links to digital image files using metadata for classification purposes. Another method utilises a hierarchical structure for storing groups of digital image files. Still further, another known method labels digital images as the images are stored in a memory of a conventional computer system.

The benefits of storing metadata within digital image files or associating such metadata externally from one or more particular image files, using a link to the image files, are well known. For example, a number of image search methods are known ranging from general search methods, methods which allow for the extraction of metadata from an image, and one known method which converts search results into particular formats preferred by a user.

The above-mentioned search methods go some way to aiding digital camera users in classifying and maintaining large sets of digital images. However, the above methods are generally targeted at sophisticated users such as librarians and other database maintainers, rather than inexperienced or casual home computer users who wish to maintain large collections of personal digital images without a commitment to learning new software or operating paradigms.

Another known method for classifying images, involves displaying a plurality of icons such that each icon is associated with a portion of metadata. An icon is subsequently selected depending on at least one subject of an image and the metadata associated with the selected icon is stored as an association of the subject of the image. However, this method suffers from similar disadvantages to those discussed above in that the method is laborious and time consuming. Each of the images to be annotated has to be generated to full screen resolution in order to determine the subject of the image. Further, metadata icons have to be individually selected and dragged to such a full screen resolution view of the image to associate the metadata of the dragged icon with the image.

Thus, a need clearly exists for an efficient and easy method of classifying and storing digital images.

### SUMMARY

It is an object of the present invention to substantially overcome, or at least ameliorate, one or more disadvantages of existing arrangements.

According to one aspect of the present invention there is provided a method of classifying one or more images, said method comprising the steps of:

selecting an iconic representation of at least one image displayed on a graphical user interface;

moving said iconic representation to a target position within an area defined by said graphical user interface, according to a classification of said image; and

determining an association between said at least one image and at least one predetermined metadata item representing said classification, in response to said iconic representation being positioned at said target position.

According to another aspect of the present invention there is provided a method of classifying one or more images, said method comprising the steps of:

selecting an iconic representation of at least one image, displayed on a graphical user interface;

moving said iconic representation to a target position within an area defined by said graphical user interface, according to a classification of said image;

creating an association between said at least one image and at least one metadata item, in response to said iconic representation being positioned at said target position; and

generating an iconic representation of said at least one metadata item representing said classification.

According to still another aspect of the present invention there is provided a method of searching for at least one image from a plurality of images, said method comprising the steps of:

selecting an iconic representation of at least one metadata item displayed on a graphical user interface;

determining an association between said at least one metadata item and said at least one image; and

generating an iconic representation of said at least one image, said iconic representation of said at least one image being adapted for display on said graphical user interface.

According to still another aspect of the present invention there is provided a graphical user interface for representing classification relationships between one or more images and one or more metadata items, said graphical user interface comprising:

selection means for moving at least one iconic representation of at least one of said images displayed on said graphical user interface, to a target position within an area defined by said graphical user interface, according to a classification of said image; and

at least one portion for displaying an iconic representation of a metadata item representing said classification, said metadata data item being generated and displayed in response to said at least one iconic representation being positioned at said target position.

According to still another aspect of the present invention there is provided an apparatus for classifying one or more images, said apparatus comprising:

selection means for selecting an iconic representation of at least one image displayed on a graphical user interface and moving said iconic representation to a target position within an area defined by said graphical user interface, according to a classification of said image; and

determining means for determining an association between said at least one image and at least one predetermined metadata item representing said classification, in response to said iconic representation being positioned at said target position.

According to still another aspect of the present invention there is provided an apparatus for classifying one or more images, said apparatus comprising:

selection means for selecting an iconic representation of at least one image, displayed on a graphical user interface and moving said iconic representation to a target position within an area defined by said graphical user interface, according to a classification of said image;

creation means for creating an association between said at least one image and at least one metadata item, in response to said iconic representation being positioned at said target position; and

generation means for generating an iconic representation of said at least one metadata item representing said classification.

According to still another aspect of the present invention there is provided an apparatus for searching for at least one image from a plurality of images, said apparatus comprising:

selection means for selecting an iconic representation of at least one metadata item displayed on a graphical user interface;

determining means for determining an association between said at least one metadata item and said at least one image; and

generation means for generating an iconic representation of said at least one image, said iconic representation of said at least one image being adapted for display on said graphical user interface.

According to still another aspect of the present invention there is provided a computer program product comprising a computer readable medium having recorded thereon a computer program for classifying one or more images, said program comprising:

code for selecting an iconic representation of at least one image displayed on a graphical user interface;

code for moving said iconic representation to a target position within an area defined by said graphical user interface, according to a classification of said image; and

code for determining an association between said at least one image and at least one predetermined metadata item representing said classification, in response to said iconic representation being positioned at said target position.

According to still another aspect of the present invention there is provided a computer program product comprising a computer readable medium having recorded thereon a computer program for classifying one or more images, said program comprising:

code for selecting an iconic representation of at least one image, displayed on a graphical user interface;

code for moving said iconic representation to a target position within an area defined by said graphical user interface, according to a classification of said image;

code for creating an association between said at least one image and at least one metadata item, in response to said iconic representation being positioned at said target position; and

code for generating an iconic representation of said at least one metadata item representing said classification.

According to still another aspect of the present invention there is provided a computer program product comprising a computer readable medium having recorded thereon a computer program for searching for at least one image from a plurality of images, said program comprising:

code for selecting an iconic representation of at least one metadata item displayed on a graphical user interface;

code for determining an association between said at least one metadata item and said at least one image; and

code for generating an iconic representation of said at least one image, said iconic representation of said at least one image being adapted for display on said graphical user interface.

According to still another aspect of the present invention there is provided a method of searching for at least one image from a plurality of images, said method comprising the steps of:

selecting a plurality of iconic representations of metadata items displayed on a graphical user interface, said iconic representations being arranged according to a hierarchical structure;

generating a query based on said selection of said plurality of iconic representations;

determining at least one association between one or more metadata items represented by the selected iconic representations and said at least one image based on said query; and

generating an iconic representation of said at least one image, said iconic representation of said at least one image being adapted for display on said graphical user interface.

According to still another aspect of the present invention there is provided an apparatus for searching for at least one image from a plurality of images, said apparatus comprising:

selection means for selecting a plurality of iconic representations of metadata items displayed on a graphical user interface, said iconic representations being arranged according to a hierarchical structure;

query generation means for generating a query based on said selection of said plurality of iconic representations;

determining means for determining at least one association between one or more metadata items represented by the selected iconic representations and said at least one image based on said query; and

iconic generation means for generating an iconic representation of said at least one image, said iconic representation of said at least one image being adapted for display on said graphical user interface.

According to still another aspect of the present invention there is provided a computer program product comprising a computer readable medium having recorded thereon a computer program for searching for at least one image from a plurality of images, said program comprising:

code for selecting a plurality of iconic representations of metadata items displayed on a graphical user interface, said iconic representations being arranged according to a hierarchical structure;

code for generating a query based on said selection of said plurality of iconic representations;

code for determining at least one association between one or more metadata items represented by the selected iconic representations and said at least one image based on said query; and

code for generating an iconic representation of said at least one image, said iconic representation of said at least one image being adapted for display on said graphical user interface.

Other aspects of the invention are also disclosed.

### BRIEF DESCRIPTION OF THE DRAWINGS

Some aspects of the prior art and one or more embodiments of the present invention will now be described with reference to the drawings and appendices, in which:

FIG. 1 shows a graphical user interface, in accordance with one arrangement;

FIG. 2 shows an example of classifying a plurality of images, using the user interface of FIG. 1;

FIG. 3 shows a further example of classifying a plurality of images;

FIG. 4 shows a still further example of classifying a plurality of images;

FIG. 5 shows an example of an iconic search on a plurality of images, using the user interface of FIG. 1;

FIG. 6 shows a further example of an iconic search;

FIG. 7 shows an example of a compound iconic search on a plurality of images, using the user interface of FIG. 1;

FIG. 8(a) shows an example of converting a search result into a new collection, using the user interface of FIG. 1;

FIG. 8(b) shows a further example of classifying a plurality of images;

FIG. 8(c) shows a step in the example of FIG. 8(b);

FIG. 8(d) shows a further step in the example of FIG. 8(b);

FIG. 8(e) shows a hierarchical structure formed during the example of FIG. 8(b);

FIG. 9 shows an example of an inverse search, using the user interface of FIG. 1;

FIG. 10 shows a further example of an inverse search;

FIG. 11 shows an example of adding region metadata to an image, using the user interface of FIG. 1;

FIG. 12 is a flow diagram showing a method of classifying one or more images;.

FIG. 13 is a flow diagram showing a method of linking an icon in the Icons window of FIG. 1(a) with a selected drop target;

FIG. 14 is a flow diagram showing a method of searching on a plurality of images;

FIG. 15 is a flow diagram showing a further method of searching on a plurality of images;

FIG. 16 is a flow diagram showing a method of associating a region of an image with one or more metadata items;

FIG. 17 is a flow diagram showing a method of editing a metadata item;

FIG. 18 is a schematic block diagram of a general-purpose computer upon which arrangements described can be practiced;

FIG. 19 is a flow diagram showing a method of removing metadata-image associations from images;

FIG. 20 is a flow diagram showing a further method of searching on a plurality of images;

FIG. 21 is a flow diagram showing a further method of classifying one or more images in accordance with another arrangement;.

FIG. 22(a) shows another example of classifying a plurality of images, using the user interface of FIG. 1;

FIG. 22(b) shows a step in the example of FIG. 22(a);

FIG. 22(c) shows a step in the exempt of FIG. 22(a);

FIG. 22(d) shows a step in the exempt of FIG. 22(a);

FIG. 22(e) shows a step in the exempt of FIG. 22(a);

FIG. 23 shows still another example of an iconic search on a plurality of images, using the user interface of FIG. 1;

FIG. 24 shows still another example of an iconic search on a plurality of images, using the user interface of FIG. 1;

FIG. 25(a) shows an example of an inverse search, using the user interface of FIG. 1;

FIG. 25(b) shows a further example of an inverse search, using the user interface of FIG. 1;

FIG. 26 shows the user interface of FIG. 1 displaying a hierarchical tree arrangement of metadata icons; and

FIG. 27 shows still another example of an iconic search on a plurality of images, using the user interface of FIG. 1.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of documents or devices, which form public knowledge through their respective publication and/or use. Such should not be interpreted as a representation by the present inventor(s) or patent applicant that such documents or devices in any way form part of the common general knowledge in the art.

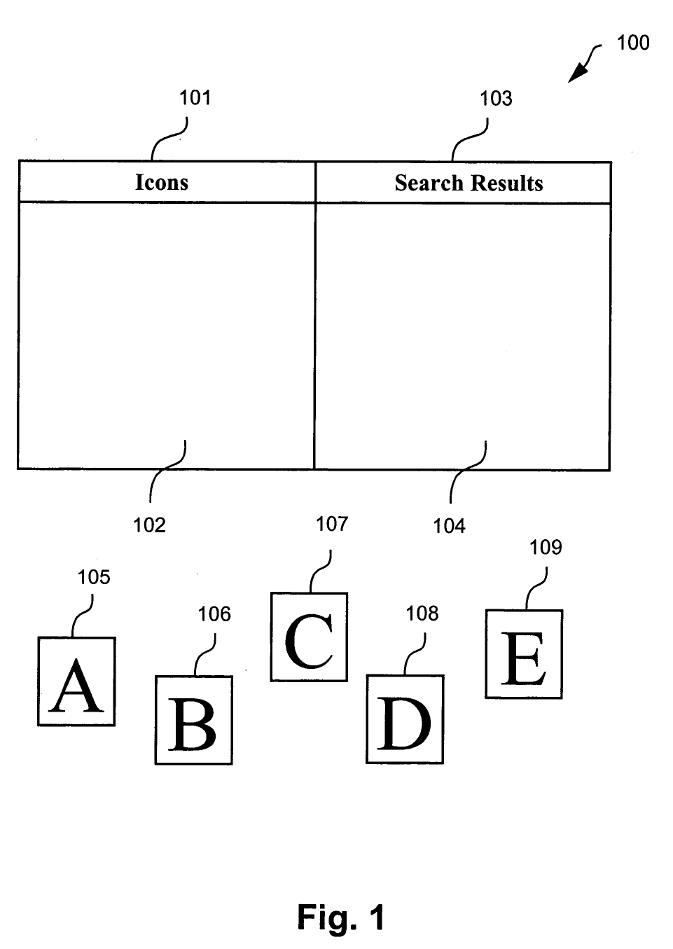

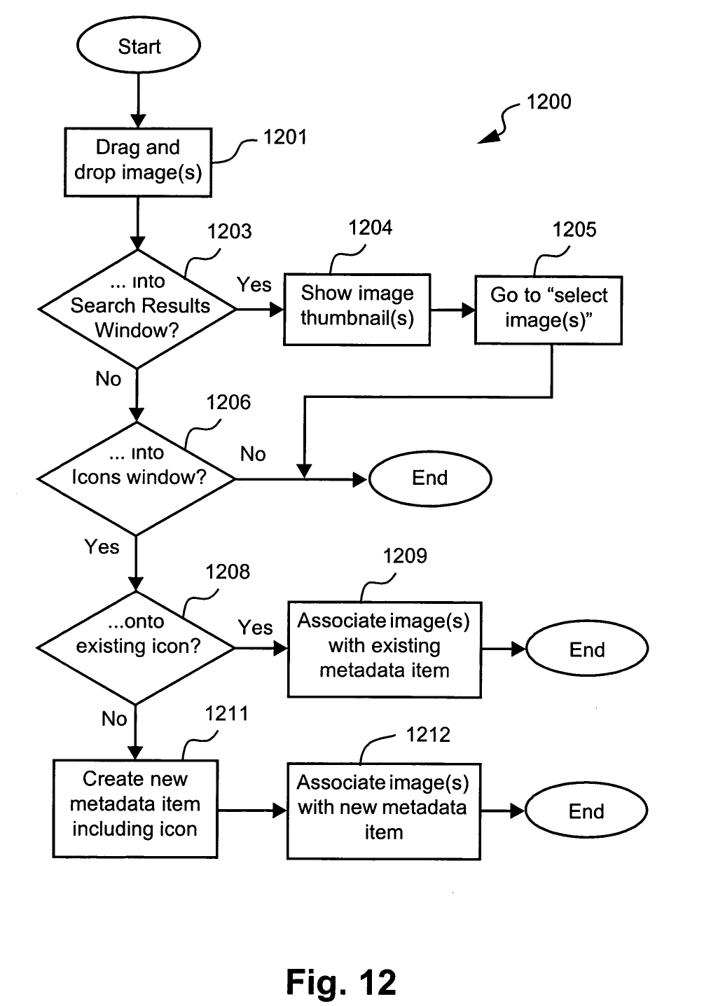

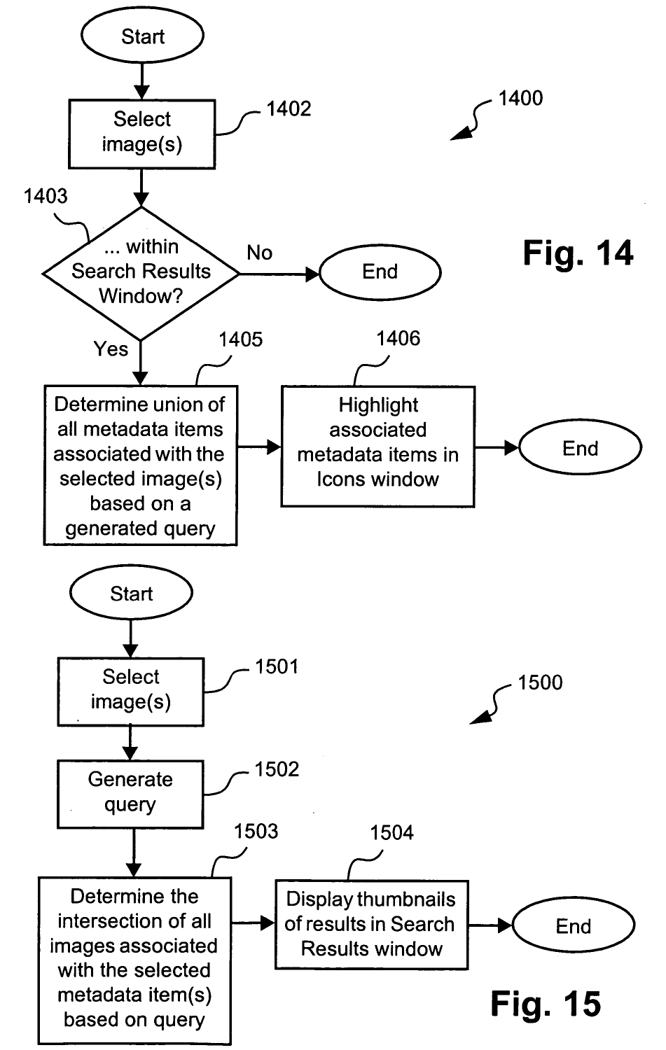

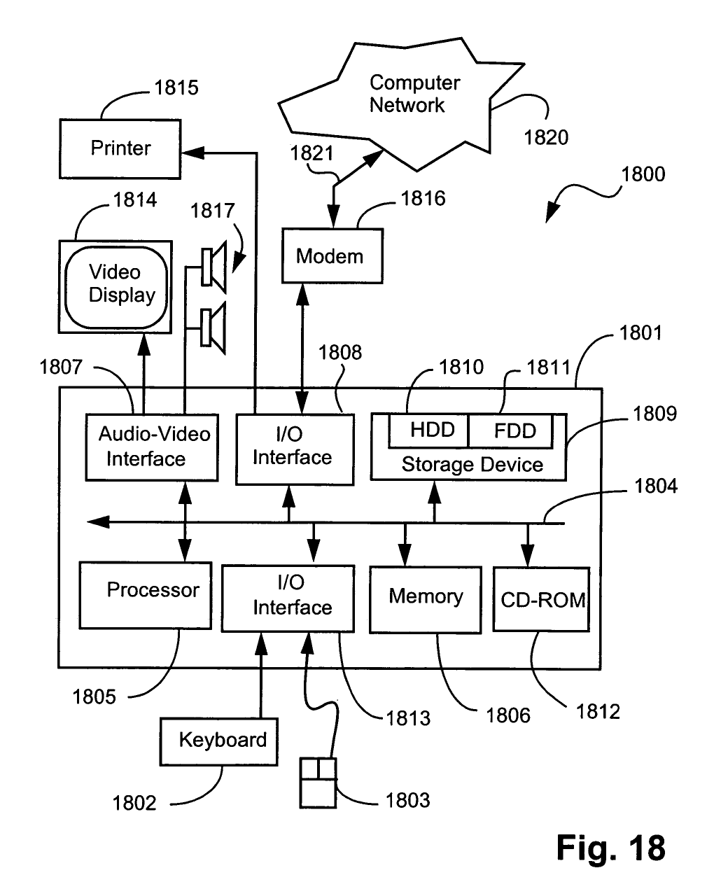

A method 1200 of classifying one or more images is described below with particular reference to FIG. 12. A method of searching on a plurality of selected images is also described with particular reference to FIG. 14. The described methods are preferably practiced using a general-purpose computer system 1800, such as that shown in FIG. 18. In particular, the processes of FIGS. 1 to 17 and 19 to 27, described below may be implemented as software, such as an application program executing within the computer system 1800. In particular, the steps of the methods described herein are affected by instructions in the software that are carried out by the computer. The instructions may be formed as one or more code modules, each for performing one or more particular tasks. The software may also be divided into two separate parts, in which a first part performs the described methods and a second part manages a user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for implementing the described processes.

The computer system 1800 is formed by a computer module 1801, input devices such as a keyboard 1802 and mouse 1803, output devices including a printer 1815, a display device 1814 and loudspeakers 1817. A Modulator-Demodulator (Modem) transceiver device 1816 is used by the computer module 1801 for communicating to and from a communications network 1820, for example connectable via a telephone line 1821 or other functional medium. The modem 1816 can be used to obtain access to the Internet, and other network systems, such as a Local Area Network (LAN) or a Wide Area Network (WAN), and may be incorporated into the computer module 1801 in some implementations.

The computer module 1801 typically includes at least one processor unit 1805, and a memory unit 1806, for example formed from semiconductor random access memory (RAM) and read only memory (ROM). The module 1801 also includes a number of input/output (I/O) interfaces including an audio-video interface 1807 that couples to the video display 1814 and loudspeakers 1817, an I/O interface 1813 for the keyboard 1802 and mouse 1803 and optionally a joystick (not illustrated), and an interface 1808 for the modem 1816 and printer 1815. In some implementations, the modem 1816 may be incorporated within the computer module 1801, for example within the interface 1808. A storage device 1809 is provided and typically includes a hard disk drive 1810 and a floppy disk drive 1811. A magnetic tape drive (not illustrated) may also be used. A CD-ROM drive 1812 is typically provided as a non-volatile source of data. The components 1805 to 1813 of the computer module 1801, typically communicate via an interconnected bus 1804 and in a manner, which results in a conventional mode of operation of the computer system 1800 known to those in the relevant art. Examples of computers on which the described arrangements can be practised include IBM-PC's and compatibles, Sun Sparcstations or alike computer systems evolved therefrom.

Typically, the application program is resident on the hard disk drive 1810 and is read and controlled in its execution by the processor 1805. Intermediate storage of the program and any data fetched from the network 1820 may be accomplished using the semiconductor memory 1806, possibly in concert with the hard disk drive 1810. In some instances, the application program may be supplied to the user encoded on a CD-ROM or floppy disk and read via the corresponding drive 1812 or 1811, or alternatively may be read by the user from the network 1820 via the modem device 1816. Still further, the software can also be loaded into the computer system 1800 from other computer readable media. The term “computer readable medium” as used herein refers to any storage or transmission medium that participates in providing instructions and/or data to the computer system 1800 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 1801. Examples of transmission media include radio or infra-red transmission channels as well as a network connection to another computer or networked device, and the Internet or Intranets including e-mail transmissions and information recorded on Websites and the like.

The methods described herein may alternatively be implemented in dedicated hardware such as one or more integrated circuits performing the functions or sub functions of the described methods. Such dedicated hardware may include graphic processors, digital signal processors, or one or more microprocessors and associated memories.

The described methods provide a user with an intuitive graphical user interface for classifying and searching on a plurality of digital images. Multiple simultaneous metadata associations and compound searches may also be performed, using the described methods. Such operations may be performed using simple user actions, which will be familiar to inexperienced or casual computer users who typically want to perform such operations on digital images without a commitment to learning new software or operating paradigms.

Metadata is associated with digital images in the described methods by selecting iconic or thumbnail representations of the images and dragging the iconic or thumbnail representations to a destination point to either create a new association for a collection of images, hereinafter referred to as “a collection”, or to associate a pre-existing metadata item with the images. Specific metadata information may be encoded within a digital image, for instance as information appended to the image header within the associated image file. Alternatively, the metadata information may be maintained in separate files stored in memory 1806, as metadata records containing metadata descriptions and references to the associated image files. Such metadata records may include fields describing attributes of a particular metadata item such as a label representing the metadata item, a reference to an icon to which the item is associated (i.e., a metadata-icon association), a reference to an image to which the item is associated (i.e., a metadata-image association) and the type of metadata item represented by the record.

Some examples of metadata types that may be associated with an identified image may include one or more of the following types:

(i) A data string;

(ii) The name of a person;

(iii) The address of a location;

(iv) Date/Time; and

(v) Actual location.

The described methods may be implemented to classify digital images locally on a particular computer such as the computer 1800 or on a plurality of remote computers (not shown) connected to the network 1820. The described methods may also be implemented as a specific application program or as one or more modules in a governing application program.

In addition to classifying digital images, the described methods allow intuitive searches on the images in a similar manner. A user may select an icon representing a metadata item of interest, and all digital images associated with the metadata item may be displayed to the user, on the display 1814, for example, as a collection of associated images. Such a collection may itself form a metadata association for a plurality of images.

Compound searches may also be performed by selecting a plurality of iconic metadata representations, in which case the intersection of all digital images associated with all selected metadata items may be displayed to a user.

Inverse searches may also be performed by selecting one or more digital images, in which case a union of all metadata items associated with any selected images may be highlighted to a user.

The methods of classifying and searching on a plurality of digital images will be described in more detail below by way of example.

FIG. 1 shows a graphical user interface 100 comprising two windows 101 and 103, which may be presented to a user on the display 1824, for example. The window 101 is titled “Icons” and has a client area 102, as known in the relevant art, which may be sized by a user in a conventional manner. Icons representing individual items of digital image metadata may be displayed within the client area 102 of the window 101.

As will be explained below, each of the icons displayed in the icons window 101 has an image association list, which lists one or more images associated with a particular icon. The association list may be stored in memory 1806 and may be updated each time one or more images are dropped onto an icon using the mouse 1803. Further, each icon displayed in the icons window may have one or more items of metadata associated with the icon.

The items of metadata associated with the icons may be stored in a central database, for example, in memory 1806. Alternatively, a database may be situated remotely and accessed via the network 1820. Each metadata item in such a database may include a record, as described above, specifying a reference to an icon to which the particular metadata item is associated.

The window 103 of the user interface 100 is preferably titled “Search Results” and also has a client area 104 of a size convenient to users. Thumbnail representations of images to be classified and images satisfying search criteria may be displayed in the window 103. FIG. 1 shows a number of thumbnail representations of unclassified images 105, 106, 107, 108 and 109, which may be classified using the methods to be described.

FIG. 12 is a flow diagram showing the method 1200 of classifying one or more images in accordance with one arrangement. The method 1200 may be implemented as software resident on the hard disk drive 1810 and being controlled in its execution by the processor 1805. The process begins at step 1201, where one or more thumbnail (or iconic) representations of images (i.e., image files) may be selected, dragged and dropped in either of the windows 101 or 102, using the mouse 1803. At the next step 1203, if the images are dropped within the client area 104 of the search results window 103, then the method 1200 proceeds to step 1204. Otherwise, the method 1200 proceeds to step 1206.

At step 1204, the processor 1805 displays the thumbnail representations of the selected images within the window 103. Then at the next step 1205, the images dropped in the window 103 remain selected (i.e., highlighted as known in the relevant art), implying that further actions follow the selection of the images, as will be described in further detail below. The method 1200 concludes after step 1205.

At step 1206, if the processor 1805 determines that the images have not been dropped within the client area of the Search Results window 103 or the Icons window 101, then the method 1200 concludes. Otherwise, if the selected images were dropped within the client area 102 of the Icons window 101, then the method 1200 proceeds to step 1208. At step 1208, if the images were dropped onto an icon already existing in the window 101, then the method proceeds to step 1209. Otherwise the method 1200 proceeds to step 1211.

At step 1209, references to the dropped images are added to an association list corresponding to the existing icon, and the method 1200 concludes. As a result, the dropped images are also associated with one or more items of metadata represented by the icon. The association between the dropped images and the metadata items (i.e., the metadata-image associations) may be implemented as a link (e.g. a pointer or reference) between the images and the metadata items, stored together with the particular metadata items in memory 1806, for example.

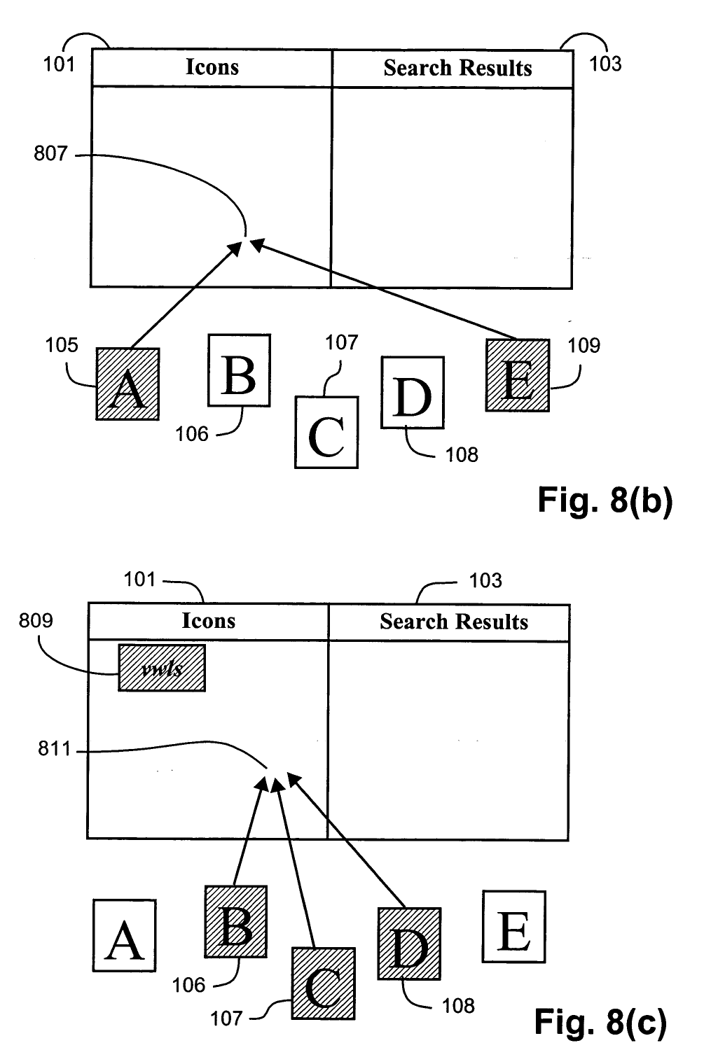

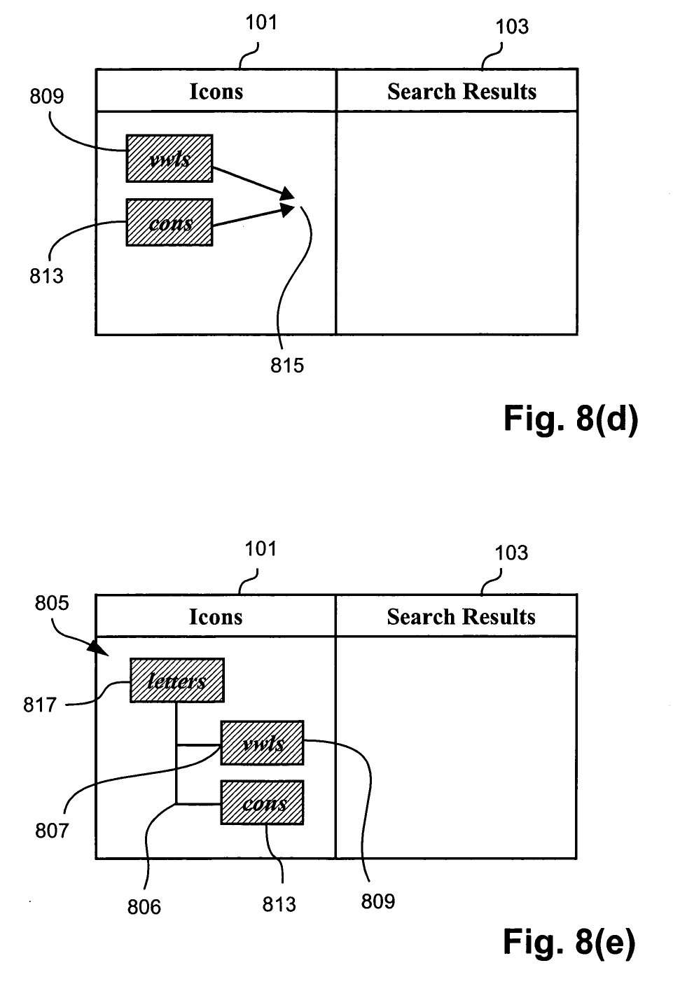

As will be explained in detail below, metadata-image associations may be represented by a hierarchical tree structure 805, for example, as seen in FIG. 8(e). The structure 805 preferably comprises nodes (e.g. 806), where each node may contain:

(i) Metadata information; and

(ii) One or more sub nodes or child nodes.

Images and corresponding image files represented by thumbnail representations may be associated with child nodes at the leaf (e.g. 807) of such a tree structure 805. Leaf nodes may also be associated with other file types such as audio and video files. Metadata items represented by icons (e.g. an icon 809) may be associated with each branch node (e.g. 806). Thus, each branch of the hierarchical tree structure 805 contains metadata information that applies to a sub tree (not shown) below that branch.

Any image being a descendant of a branch is associated with the metadata item represented by a metadata icon corresponding to the branch. A collection of metadata items may therefore be stored in memory 1806 in a form representing a single hierarchical tree structure. Such a collection may be stored in a central database locally within the computer 1800 or accessed over the network 1820. The tree structure 805 may be readily read to and from a file stored on the hard disk drive 1810 for persistence between operations.

If the images selected at step 1201 of the method 1200, are dropped onto an empty point within the client area 102 of the icons window 101, at step 1208, then the method 1200 proceeds to step 1211. At step 1211, the processor 1805 generates a new icon representing an item of metadata. The item of metadata represented by the icon generated at step 1211 may be read from the file header of one or more of the dropped images. Alternatively, the processor 1805 may read a reference, associated with the dropped images, to an item of metadata stored in memory 1806. At the next step 1212, a reference (i.e., metadata-image association) to the item of metadata generated at step 1211 is stored in memory 1806, and the method 1200 concludes. As described above, the metadata-image associations may be stored in memory 1806 as metadata records comprising a reference to the image or images dropped into the Icons window 101 at step 1201.

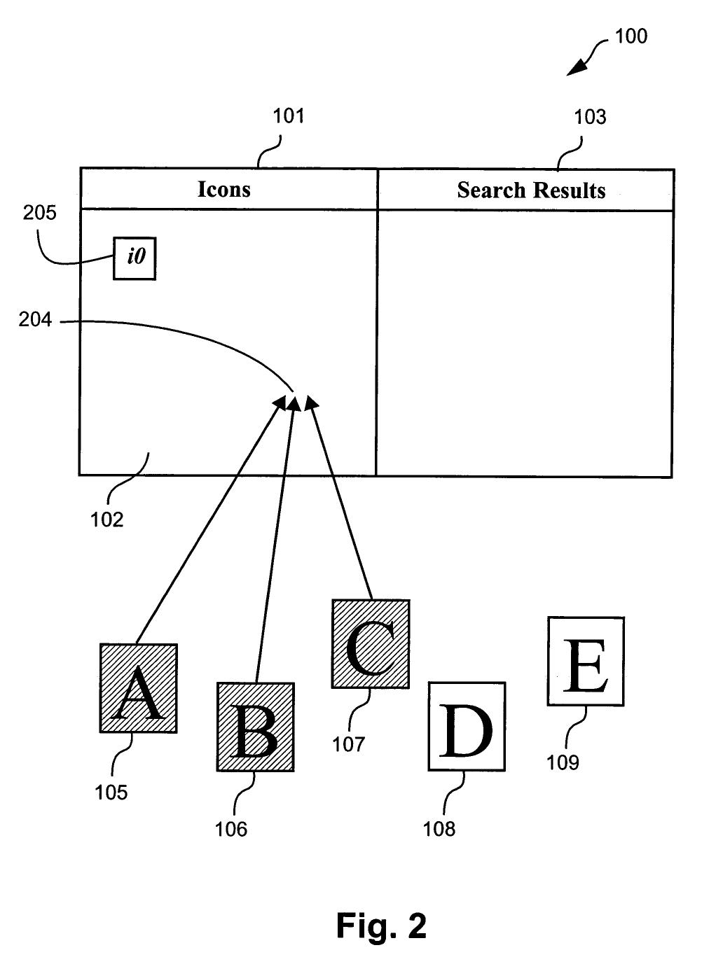

Continuing the example of FIG. 1, FIG. 2 shows three of the images 105, 106 and 107, which have been selected and dragged to a point 204 within the client area 102 of the icons window 101. As a result, an icon 205 (i.e., labelled “i0”) representing a metadata item is generated by the processor 1805, as at step 1211 of the method 1200. The metadata item represented by the icon 205 may be read from the file header of each of the images 105, 106 and 107. Alternatively, the processor 1805 may read a reference, associated with the dropped images 105, 106 and 107, to an item(s) of metadata stored in memory 1806. A collection has thus been generated, where the collection contains the selected images 105 to 107. The metadata item(s) associated with the selected images 105 to 107 has not been initialised. The initialisation of metadata will be described below.

Multiple images may be selected by pressing a key (e.g. the control key) on the keyboard 1802, while clicking the mouse 1803 on each thumbnail representation of the images in turn or sweeping the mouse 1803 over an area that contains the thumbnail representations representing the multiple images.

To initialise the metadata item associated with the images 105 to 107, the user may double click on the icon 205 in a conventional manner or select the icon 205 and press a Properties Button, as known in the relevant art, to launch a Metadata Editor window (not shown). The Metadata Editor window (not shown) may be used to display and edit the metadata fields (e.g. label, icon, type etc) of the metadata record associated with the icon 205 selected. Such a Metadata Editor window may allow a suitable and readily identified thumbnail representation to be associated with the metadata item. The Metadata Editor window may also allow a user to select the type of metadata, the value of the metadata and a label to be displayed with a metadata icon for representing the metadata.

Alternatively, a metadata item may be initialised by prompting a user to select an appropriate icon. Further, a default thumbnail icon may be generated and displayed in the icons window 101, when a new icon (e.g. the icon 205) and metadata item is being generated. The default icon may be replaced by an appropriate thumbnail representation at a later time through some convenient method such as right clicking on the default icon. The label (e.g. ‘i0’) associated with an icon may be visible and editable as a text box. A selected image or an image selected first from any plurality of images may form a default thumbnail icon. Further, an abbreviation of such a selected image or the first selected image may make a suitable label for such a default icon.

Continuing the example of FIGS. 1 and 2, the classification of the images 107 and 108 may be performed by selecting the images 107 and 108, dragging the images 107 and 108 into the client area 102 of the window 101, and dropping the images 107 and 108 on the existing icon 205, as at steps 1202 to 1208 of the method 1200. As the image 107 is already associated with the icon 205 and the corresponding metadata item, no further processing is performed on the image 107. Preferably, no error conditions are generated by the processor 1805 in this instance. However, in contrast to the image 107, the image 108 is foreign to the set of images associated with the icon 205. Thus, the image 108 is added to the image association list of the icon 205 and a metadata-image association is added to the metadata item record corresponding to the icon 205. As such, the image 108 is added to the collection of images associated with the icon 205.

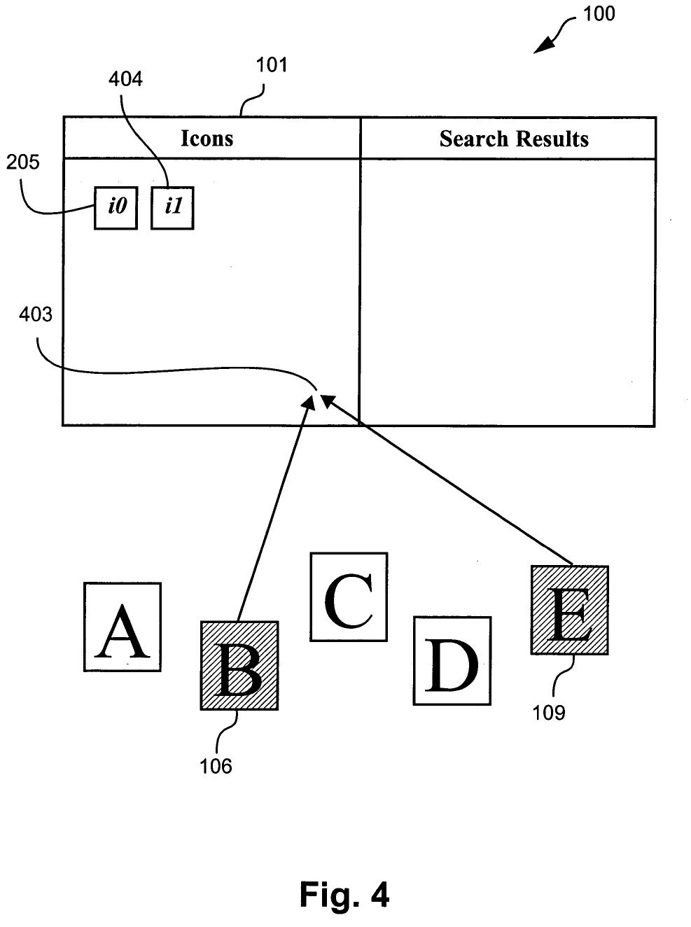

As seen in FIG. 4, the two images 106 and 109 may then be selected and dragged in a conventional manner to an empty point 403 within the icons window 101 client area 102. As a result, another new metadata item is generated by the processor 1805, and an icon 404 representing the metadata item (i.e., labelled “i1”) is generated. Another collection has thus been generated containing the selected images 106 and 109. This further collection is associated with the new item of metadata, although again, the metadata item does not have to be initialised at the time that the collection is generated. The metadata item associated with the icon 404 may be initialised as described above for the icon 205.

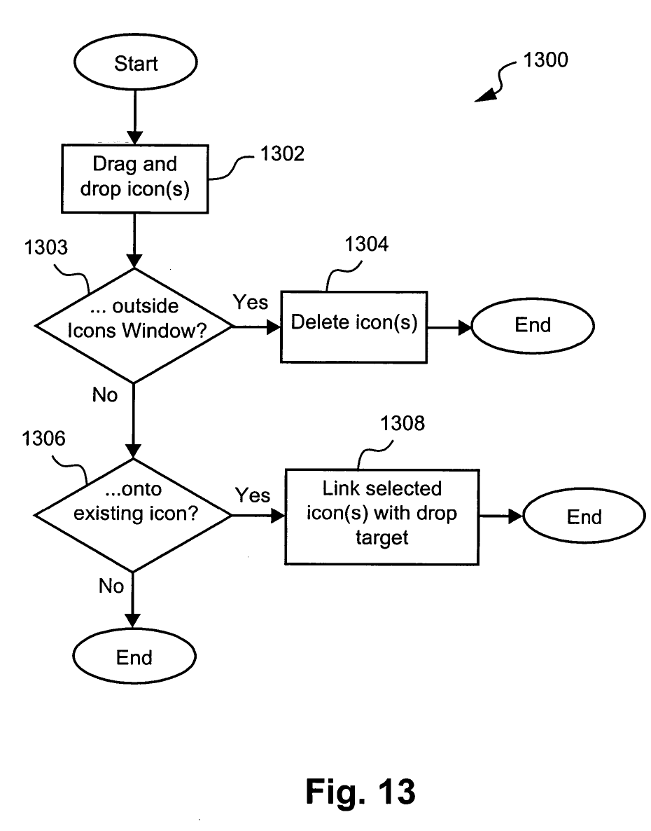

FIG. 13 is a flow diagram showing a method 1300 of linking an icon (e.g. the icon 205) in the Icons window 101 with a selected drop target (e.g. the icon 404). The method 1300 may be implemented as software resident on the hard disk drive 1810 and is controlled in its execution by the processor 1805. The process begins at step 1302, where one or more icons (e.g. the icon 205) in the icons window 101 are selected, dragged and dropped, in a conventional manner using the mouse 1803. At the next step 1303, if the icons are dropped within the client area 102 of the icons window 101, then the method 1300 proceeds to step 1304. Otherwise, the method 1300 proceeds to step 1306.

At step 1304, the processor 1805 deletes the dropped icons, and the method 1300 concludes.

The method 1300 continues at step 1306, where if the icons (e.g. the icon 205) were dropped onto an existing icon (e.g. the icon 404) in the window 101, then the method proceeds to step 1308. Otherwise the method 1300 concludes. At step 1308, any metadata items and images associated with the dropped icons are associated with the existing icon. Such associations are formed by updating the image association list and metadata records of the existing icon to include reference images associated with the dropped icons. Any future images dropped on the existing icon will be associated with all of the metadata items of the existing icon and the metadata items of the dropped icons that were associated with the existing icon in step 1308. The method 1300 concludes after step 1308.

FIG. 14 is a flow diagram showing a method 1400 of searching on a plurality of selected images. The method 1400 may be implemented as software resident on the hard disk drive 1810 and being controlled in its execution by the processor 1805. The process begins at step 1402, where one or more images (or thumbnail representations) are selected using the mouse 1803 in a conventional manner. As described above, multiple images may be selected by pressing a key (e.g. the control key) on the keyboard 1802, while clicking the mouse 1803 on each thumbnail image representation in turn or sweeping the mouse 1803 over an area that contains the thumbnails representing the multiple images.

At the next step 1403 of the method 1400, if the selection of images occurs outside the search results window 103, then no further processing is executed and the method 1400 concludes. Otherwise, if the selection of images occurs within the client area 104 of the search results window 103 then the method 1400 proceeds to step 1405.

At step 1405, the processor 1805 generates a query to determine the union of all metadata items associated with any of the selected images. Based on the generated query, the processor 1805 determine the union of all metadata items associated with any of the selected images. Then at the next step 1406, any icons associated with those metadata items of the selected images are highlighted, in a conventional manner, in the icons window 101.

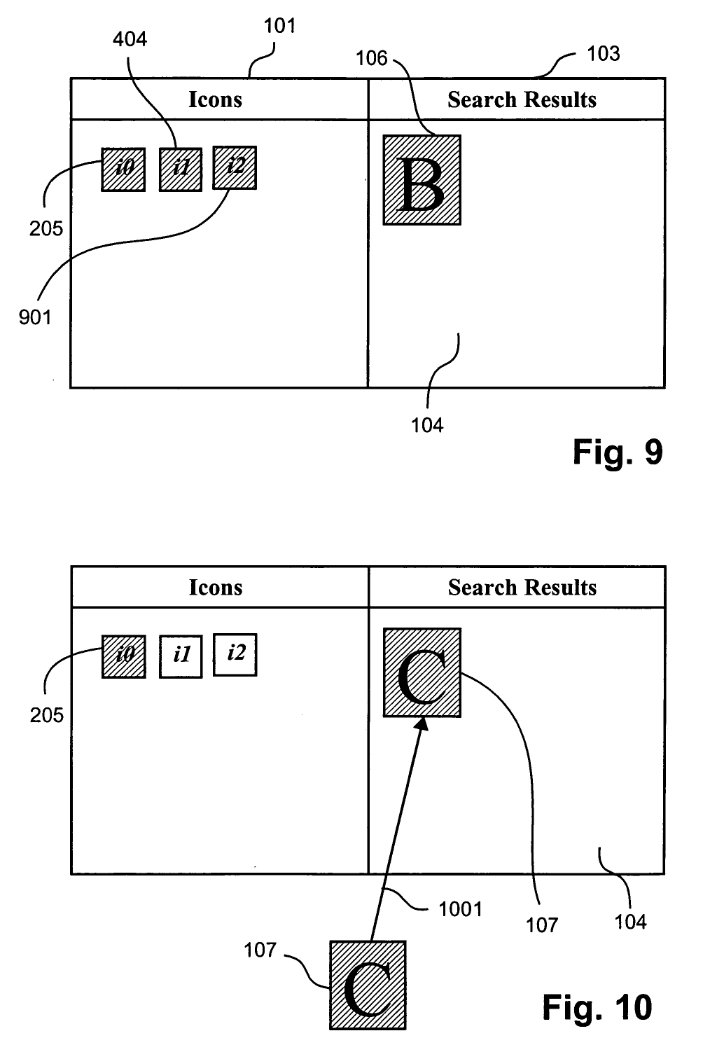

The method 1400 is an example of an inverse search. For example, turning now to FIG. 9 an image 106 selected in the search results window 103 (i.e., the thumbnail representation of the image 106 is highlighted in a conventional manner (e.g. shading)). Further, all metadata icons (e.g. the icons 205, 404 and 901) associated with the selected image 106 are themselves highlighted. In other words, selecting one or more images in the search results window 103 results in the highlighting of all metadata icons associated with those images. Inverse searching in this manner allows a user to quickly and easily determine, which items of metadata are associated with a particular image or set of images in a visual manner.

An image need not be displayed in the search results window 103 to perform an inverse search. For example, FIG. 10 shows the image 107 dragged (i.e., as indicated by the arrow 1001) from outside the windows 101 and 103 and dropped within the client area 104 of the search results window 103. As a result, the image 107 is selected and highlighted in accordance with the method 1400. Therefore, an inverse search may be performed by the selection of the image 107, which indicates that the metadata item represented by icon 205 is associated with the image 107. Alternatively, the user may choose to search for the intersection of metadata items associated with the selected images, when performing an inverse search.

As described above, the association of metadata items with images forms a symmetrical relationship. That is, associating an image with a metadata item represented by an icon, allows a user to classify the images. Further, listing those images associated with a set of metadata items and/or listing those metadata items associated with a set of images, allows a user to search on a plurality of digital images.

FIG. 15 is a flow diagram showing a further method 1500 of searching on a plurality of images. The method 1500 is preferably implemented as software resident on the hard disk drive 1810 and being controlled in its execution by the processor 1805. The process begins at step 1501, where one or more icons are selected using the mouse 1803, in a conventional manner. Multiple icons may be selected by pressing a key (e.g. the control key) on the keyboard 1802, while clicking the mouse 1803 on each icon in turn or sweeping the mouse 1803 over an area that contains the icons. At the next step 1502 of the method 1400, the processor 1805 generates a query to determine the intersection of all images associated with any of the selected icons. At the next step 1503 of the method 1400, the processor 1805 determines the intersection of all images associated with any of the selected icons, based on the generated query. The images may be determined at step 1503 based on the generated query by reading image references out of the association lists of each of the selected icons and determining which of the images satisfy the generated query. Then at the next step 1504, thumbnail representations of those images determined at step 1503, are displayed in the search results window 103, and the method 1500 concludes. A new collection based on the images determined at step 1503 (i.e., the search results), may be created in the manner described above.

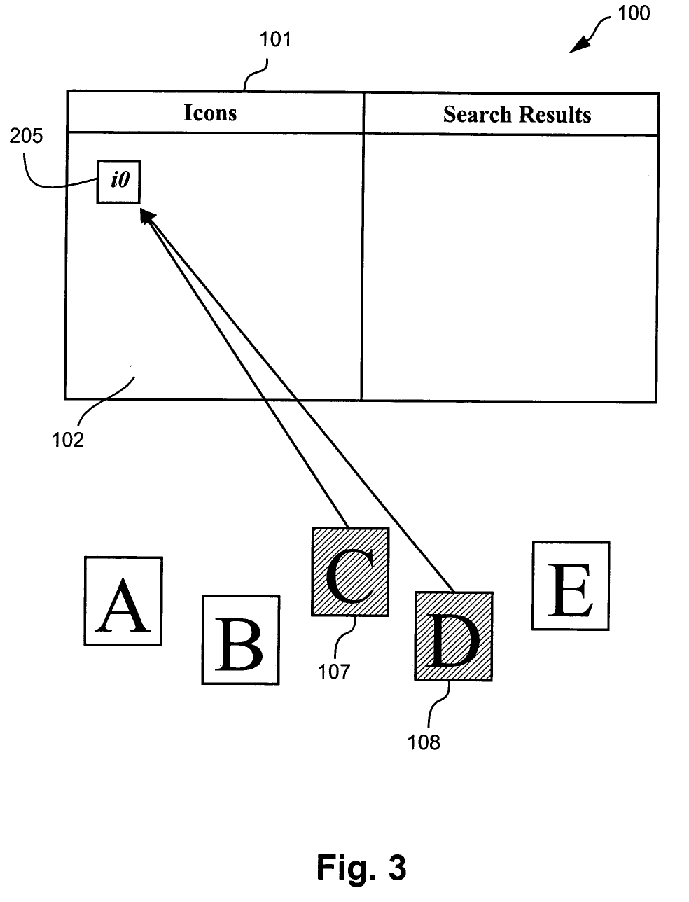

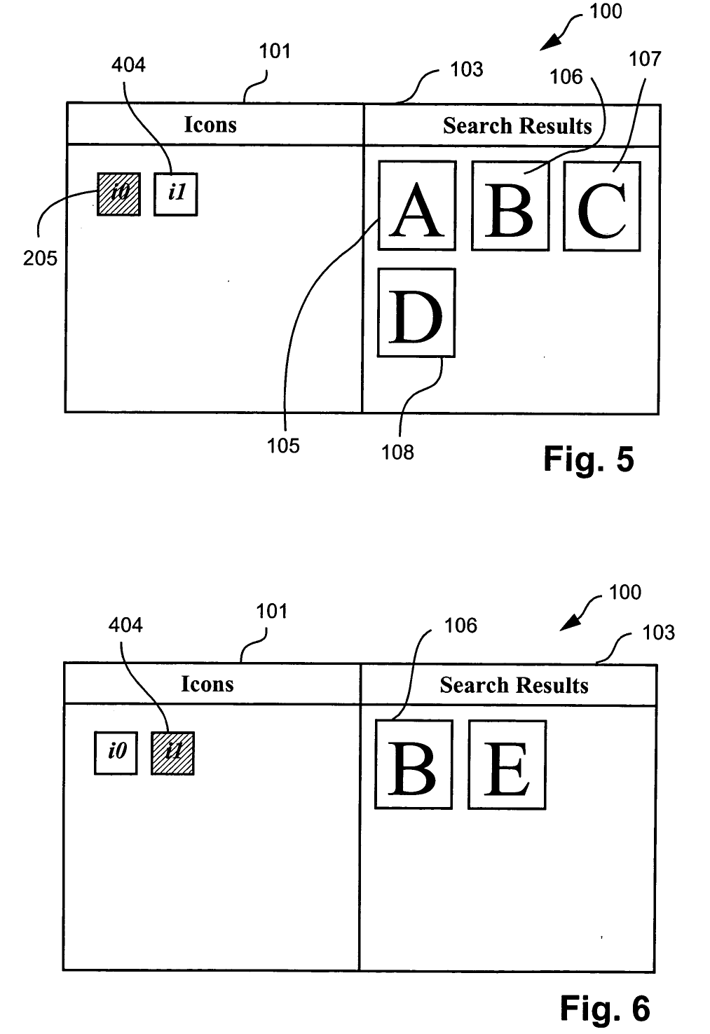

The method of 1500 is an example of a simple forward search. For example, FIG. 5 shows the icon 205 selected and highlighted in a conventional manner (i.e., by shading), as at step 1502 of the method 1500. Selecting the icon 205 results in the images 105, 106, 107 and 108 associated with the icon 205, being displayed in the Search Results window 103. As described above with reference to FIGS. 2 and 3, the images 105, 106, 107 and 108 were previously classified as belonging to the icon 205 and the metadata items of the icon 205.

FIG. 6 shows an example of another simple forward search performed by a user selecting the icon 404. As a result of the selection, the images 106 and 109 previously classified as belonging to the icon 404 are displayed in the search results window 103. In this instance, the search results window 103 is preferably cleared (i.e., removing previous search results) before displaying the current search results (i.e., the images 106 and 109).

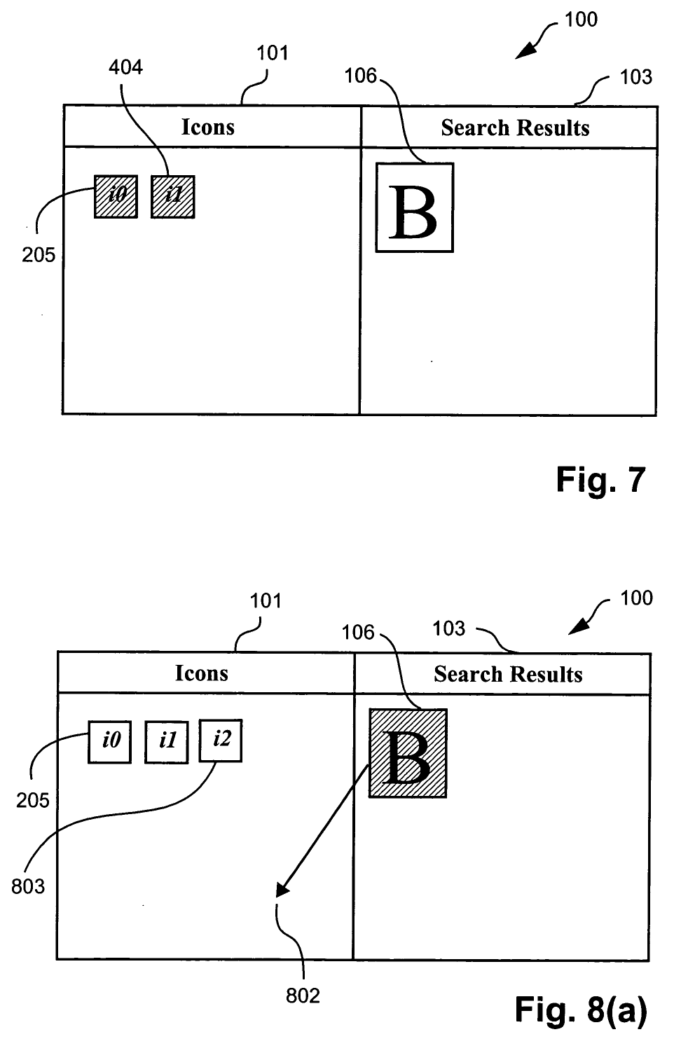

FIG. 7 shows an example of a compound forward search. A compound forward search is executed by the processor 1805 if more than one icon (e.g. both of the icons 205 and 404) is selected. In this instance, thumbnail representations of each image associated with each of the icons 205, 404 representing metadata items, are displayed in the Search Results window 103. In the present example of FIG. 7, the image 106, which is common to both icons 205 and 404, is displayed in the window 103. As such the result of the compound search is defined as the intersection of the association lists, corresponding to the selected icons, with all selected metadata items. The selection of one or more metadata icons, as described above, allows a user to perform compound searches quickly and intuitively, without the need to provide a sophisticated query as is required by most conventional searching methods. Such queries are generated by the processor 1805 based on the selection of icons and may include many operators and associated operations depending on the number of icons selected. Alternatively, a user may choose to search for the union of association lists associated with metadata items. Multiple images (e.g. the image 106) from the search results window 103 may be classified simultaneously by selecting such images in the window 103 before dragging the selected images into the window 101. For example, FIG. 8(a) shows the image 106 being dragged from the search results window 103 onto an empty point 802 within the icons window 101. As a result, a new uninitialised metadata item represented by icon 803 and associated with the image 106, is generated by the processor 1805. The new metadata item represented by the icon 803 may be initialised as described above.

Similarly, one or more images may be dragged from the search results window 103 onto an existing icon (e.g., the icon 205) to associate those dragged images with the particular metadata item(s) represented by the icon.

As described above, one or more images may be associated with one or more metadata items (i.e., classified) using the mouse 1803 in a conventional drag and drop manner. The images may be selected and dragged from within the window 103. Alternatively, thumbnail representations of images may be selected from outside the graphical user interface 100. For example, images may be selected from another application being executed on the computer 1800 or on a remote processor accessed via the network 1820.

Icons (e.g. the icons 205, 404 and 803) may be deleted by dragging the icons outside the icons window 101 and dropping the icons, using the mouse 1803. Alternatively, icons may be deleted using some other user action such as right clicking the mouse 1803 on the icons to be deleted to bring up a context menu, as known in the relevant art, and selecting a “delete icon” option.

Icons that are selected, dragged and dropped on top of another existing icon are associated with the existing icon and the metadata items represented by the existing icon. For example, if the icon 205 is dragged and dropped onto the icon 803, then the icon 205 is associated with icon 803. In this case, icon 205 is termed the “child icon” and icon 803 is termed the “parent icon”. As a result, any further operations on metadata items associated with the icon 803 are associated with any images listed in the association list corresponding to the icon 205. However, the relationship between the icons 205 and 803 is not commutative, in this instance.

Dragging and dropping icons onto existing icons, as described above, creates a parent-child relationship between the icons. This relationship may be represented by a metadata icon tree structure (e.g. the tree structure 805 as seen in FIG. 8(e)). For example, the image 105 of an “A” and the image 109 of an “E”, as seen in FIG. 8(b), may be dragged and dropped onto an empty point 807 in the Icons window 101. As a result, the processor 1805 generates an uninitialised metadata item, represented by an icon 809, associated with the two images 105 and 109. The item of metadata represented by the icon 809 may be read from the file header of the dropped images 105 and 106. Alternatively, the processor 1805 may read a reference, associated with the dropped images, to an item of metadata stored in memory 1806. In the present example, the item of metadata associated with the images 105 and 109 is “vwls”. As such, the new icon 809 is labelled “vwls” by the user, using a text box generated within the icon 809, for example. The icon 809 may be used to describe a subset of vowels (i.e., “A” and “E”), in the present example.

Continuing the present example, the user then selects, drags and drops the image 106 of a “B”, the image 107 of a “C” and the image 108 of a “D”, onto an empty point 811 within the Icons window 811, as shown in FIG. 8(c). As a result a new icon 813 representing an uninitialised metadata item is generated by the processor 1805, as seen in FIG. 8(d). In the present example, the item of metadata associated with the images 106 and 107 is “cons”. The new icon 813 is subsequently labelled “cons” by the user to describe a subset of consonants (i.e., the images 106, 107 and 108, representing the letters “B”, “C” and “D”).

Continuing the present example, the user selects the icons 809 and 813, drags and drops the icons 809, 813 (i.e., labelled “vwls” and “cons”) onto an empty point 815 within the icons window 101, as shown in FIG. 8(d). As a result, a new icon 817 representing a new metadata item is generated and displayed in the window 101. The information fields (e.g. label, icon, type etc) of the new metadata item represented by the icon 817 are not yet initialised. However, these information fields may be initialised by the user on the basis that the icons 809 and 813 (i.e., “vwls” and “cons”) are children of the icon 817. In the present example, the new metadata item may be initialised to “letters”. The icon 817 is labelled “letters” by the user, as seen in FIG. 8(e), and represents a subset of letters of the alphabet. The subset of characters represented by the icon 817 has been further specialised into subsets representing vowels and consonants.

In one arrangement, upon generation and initialisation of the icon 817, the processor 1805 may examine all of the images 105 to 109, and update the metadata items associated with each of the images to include all of the further metadata items. For example, the images 105 and 109 are associated with the metadata icon 809 and have an associated metadata item “vwls”. Further, the images 106, 107 and 108 are associated with the metadata icon 813 and have an associated metadata item “cons”. Still further, each of the images 105 to 109 are associated with the metadata icon 815 representing the metadata item “letters”. Accordingly, upon generation and initialisation of the icon 817, the images 105 to 109 may be updated to include the metadata item “letters”. In this instance, the metadata item “letters” may be appended to the image header within the image files associated with each of the images 105 to 109.

As described above, the relationship between the icons 809, 813 and 817 may be represented by the hierarchical tree structure 805. However, the relationship between the icons 809, 813 and 817 may be represented in any suitable form (e.g., a table). Further icons (not shown) may be similarly dragged and dropped onto the existing icons 809, 813 and 817 to create further parent-child relationships between the further icons and the existing icons 809, 813 and 817. As such, a new uninitialised parent icon does not need to be created for these further icons. However, upon the images being dropped onto the exiting icons 809, 813 and 817, the images 105 to 109 may each be updated to include the metadata items associated with one or more of the icons 809, 813 and 817 depending on which icon the images were dropped on.

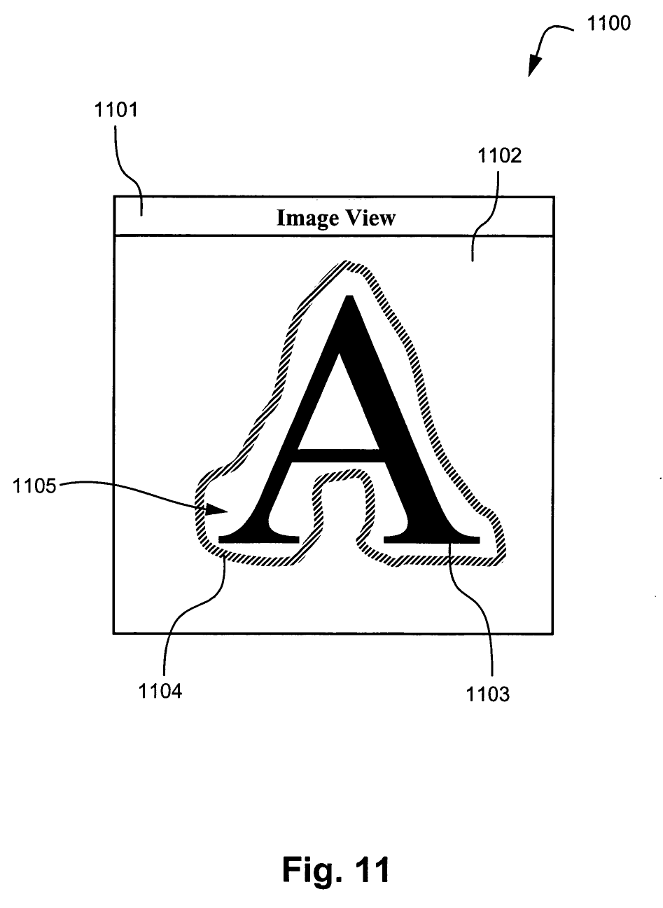

Double clicking on an image in the search results window 103 or selecting an image in the search results window 103 and pressing a ‘Properties Button’, may be performed by a user in order to generate an image view window 1100, as shown in FIG. 11. The window 1100 may be titled “Image View” 1101. The window 1100 contains a client area 1102 which shows a screen resolution representation 1103 of the letter “A”, which was previously represented by the thumbnail representation 105, as described above.

In one example, if a user drags the mouse 1803 in a path 1104 that approximates the outline shape of the representation 1103 (i.e. the shape of the letter “A”), and then selects one or more icons (e.g., 205, 404 or 901) within the Icons window 101, then the region 1105 within the path 1104 is associated with the one or more selected icons and corresponding metadata items. The region 11 05 is closed by the processor 1805 to form a closed outline described by spline curves. If the representation 1103 was not previously associated with any of the corresponding metadata items then new metadata-image associations are created, by adding a reference to the image represented by the region 1105 to the association lists and metadata records of the selected icons.

A person skilled in the relevant art would appreciate that any suitable method for describing a region within an image (e.g. the region 1105) may be used. For example, a user may drag a rectangular outline or an outline of any other geometric shape, or single click region detection using the mouse 1803. Once the association with such a region has been created, then a modified form of inverse search can be performed from the image view window 1100. In order to perform such an inverse search, a user may click on a pixel within the image including the created region (e.g. the region 1105), using the mouse 1803. As a result, the following icons will be highlighted in the Icons window 101:

(a) Those icons corresponding to metadata items associated with the region (e.g. the region 1105) within which the user has clicked; and

(b) Those icons corresponding to metadata items associated with the image, which includes the region but with no specific region metadata-image associations.

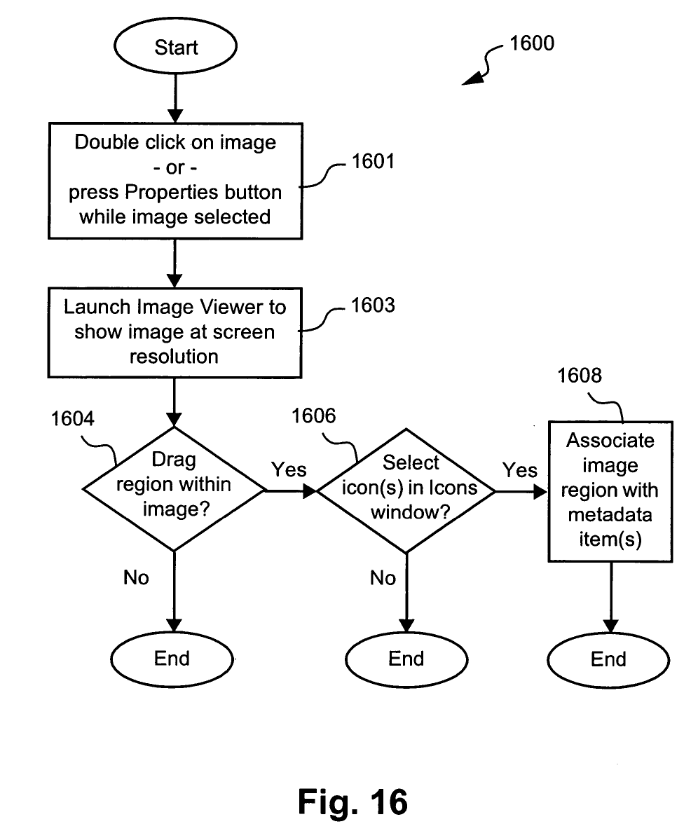

FIG. 16 is a flow diagram showing a method 1600 of associating a region with one or more metadata items. The method 1600 may be implemented as software resident on the hard disk drive 1810 and being controlled in its execution by the processor 1805. The process begins at step 1601, where an image (e.g. the image 1103) within the search results window 103 is selected by double clicking on the image using the mouse 1803. Alternatively, the image may be selected using a “Properties Button” or “menu item”, as known in the relevant art.

At the next step 1603, an image view window (e.g. the window 1100) is launched by the processor 1805 to show the image at screen resolution. Depending on the size of the image, the window 1100 may include a scroll bar. The method 1600 continues at the next step 1604, where if a mouse pointer associated with the mouse 1803 is not dragged within the window 1100 to define a region (e.g., the region 1105), then the method 1600 concludes.

If a region (i.e., typically following an outline shape within the image) is defined within the window 1100, then the method 1600 proceeds to step 1606. At step 1606, if an icon (e.g. the icon 205) is selected within the icons window 101, then the method 1600 proceeds to step 1608. Otherwise, the method 1600 concludes. At step 1608, the region defined within the window 1100 at step 1604 is associated with the icon selected at step 1606, in the manner described above, and the method 1600 concludes.

During the execution of the method 1600, one or more icons may be selected without a search being performed and without updating the contents of the search results window 103. The method 1600 and any search are performed in two clearly defined and mutually exclusive states (i.e., when the Image View window 1100 is either open or closed).

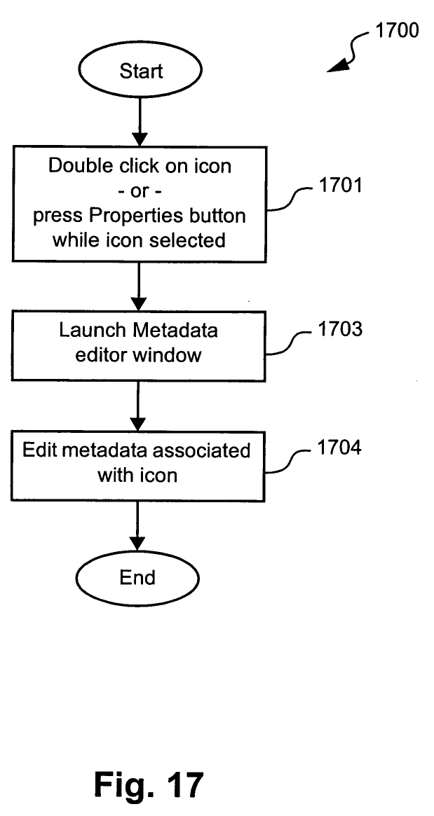

FIG. 17 is a flow diagram showing a method 1700 of editing a metadata item. The method 1700 may be implemented as software resident on the hard disk drive 1810 and being controlled in its execution by the processor 1805. The process begins at step 1701, where an icon (e.g. the icon 205) within the icons window 101 is selected by double clicking on the icon using the mouse 1803. Alternatively, the icon may be selected using a properties button or menu item, as known in the relevant art.

At the next step 1703, a Metadata Editor window (not shown) is launched by the processor 1805 to display the metadata fields (e.g. label, icon, type etc) of the metadata record associated with the icon selected at step 1803. The method 1700 concludes at the next step 1704 where the metadata fields are edited by a user and the metadata editor window is closed in a conventional manner using the mouse 1803.

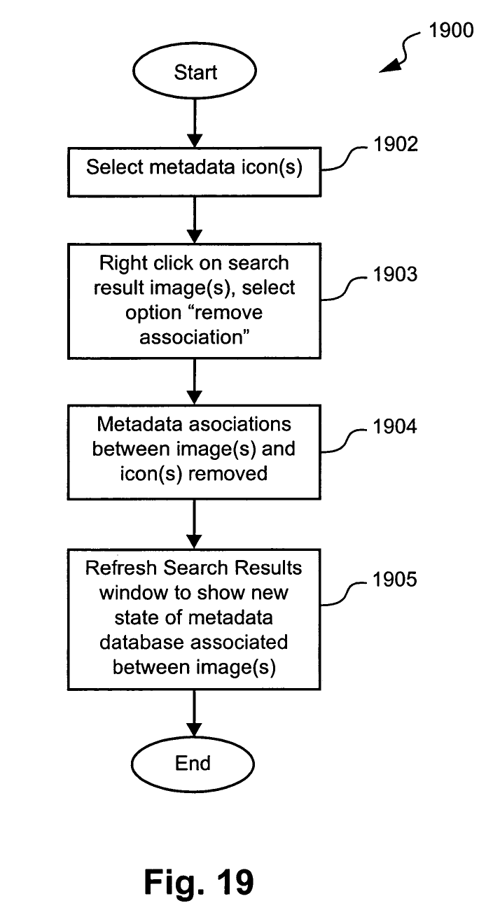

FIG. 19 is a flow diagram showing a method 1900 of removing metadata-image associations from images. The method 1900 may be implemented as software resident on the hard disk drive 1810 and being controlled in its execution by the processor 1805. The process begins at step 1902, where one or more icons (e.g. the icon 205) within the icons window 101 are selected by double clicking on the icons using the mouse 1803. In response to the selection of the icons, the processor 1805 generates a query to determine the intersection of all images associated with any of the selected icons, in accordance with the method 1500. Also at step 1902, those images determined to be associated with the selected icons, are displayed in the search results window 103, as thumbnail representations (e.g., the thumbnail representations 105 to 109). Then at the next step 1903, one or more of the thumbnail representations displayed at step 1902, are selected. The thumbnail representations may be selected by right clicking the mouse 1803, for example, to bring up a context menu. A “remove associations” option can be selected from such a context menu.

The method 1900 continues at the next step 1904, where the metadata-image associations previously stored in memory 1806 corresponding to the images represented by the displayed thumbnail representations and each of the metadata items represented by the selected icons, are removed from the metadata database stored in memory 1806, for example. The method 1900 concludes at the next step 1905, where the thumbnail representations displayed in the search results window 103, are refreshed with a new search to visually confirm the new state of the metadata database to the user. That is, any thumbnails representing images, which were removed from the metadata database, are removed from the search results window 103.

Alternative methods of removing metadata-image associations may be used. For example, a set of icons may be selected and images determined to be associated with the selected icons, may be displayed in the search results window 103, as thumbnail representations (e.g., the thumbnail representations 105 to 109), in accordance with the method 1500. The displayed thumbnail representations may then be selected and dragged from the search results window 103 and dropped outside the window 103. As a result the images represented by the selected thumbnails may be removed from the association lists corresponding to the selected icons.

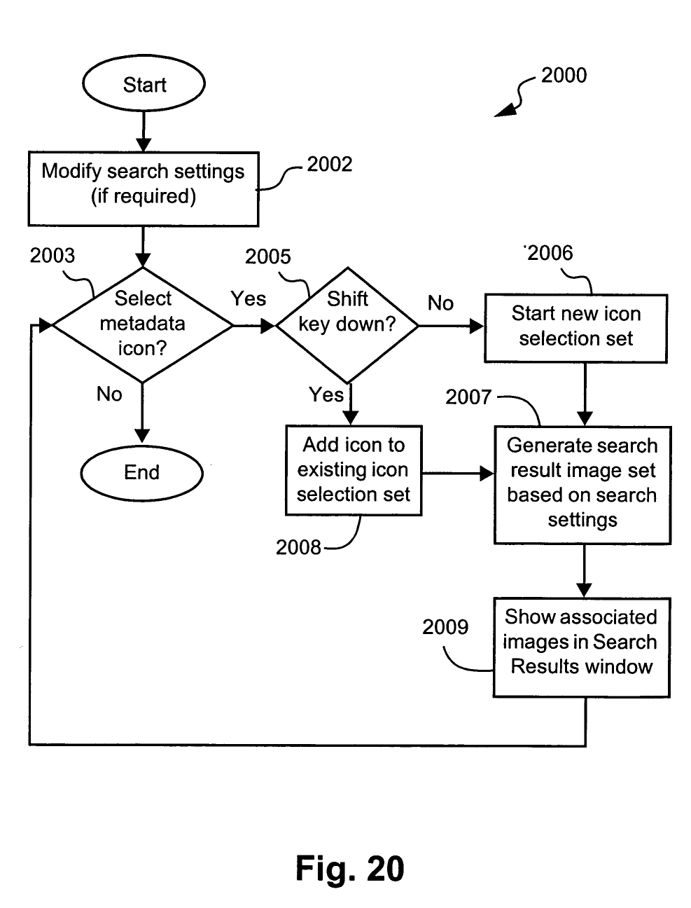

FIG. 20 is a flow diagram showing a further method 2000 of forward searching on a plurality of images. The method 2000 is may be implemented as software resident on the hard disk drive 1810 and being controlled in its execution by the processor 1805. The process begins at step 2002, where search settings may be modified. Such settings may comprise instructions for handling specific search criteria (e.g. whether the search is to contain the union or intersection of target images). Also at step 2002, an icon selection list is configured within memory 1806 and is initialised to empty. Then at the next step 2005, if one or more icons in the icons window 101 are selected, the method 2000 proceeds to step 2005. Otherwise the method 2000 concludes.

At step 2005, if the processor 1805 determines that a shift key of the keyboard 1802 was depressed when the one or more icons were selected at step 2003, then the method 2000 proceeds to step 2008. Otherwise the method 2000 proceeds to step 2006, where the processor 1805 re-initialises the icon selection list to only contain the icon selected at step 2003. A person skilled in the relevant art will appreciate that any other suitable key (e.g. the control key) can be used to perform the test at step 2005.

The method continues at step 2008, where a reference to the selected icon(s) is added to the icon selection list. Then at the next step 2007, the processor 1805 determines the intersection of all images associated with any of the selected icons, in accordance with the method 1500. At the next step 2009, those images determined to be associated with the selected icons, are displayed in the search results window 103, as thumbnail representations (e.g., the thumbnail representations 105 to 109), and the method 2000 returns to step 2003 to await further icon selections.

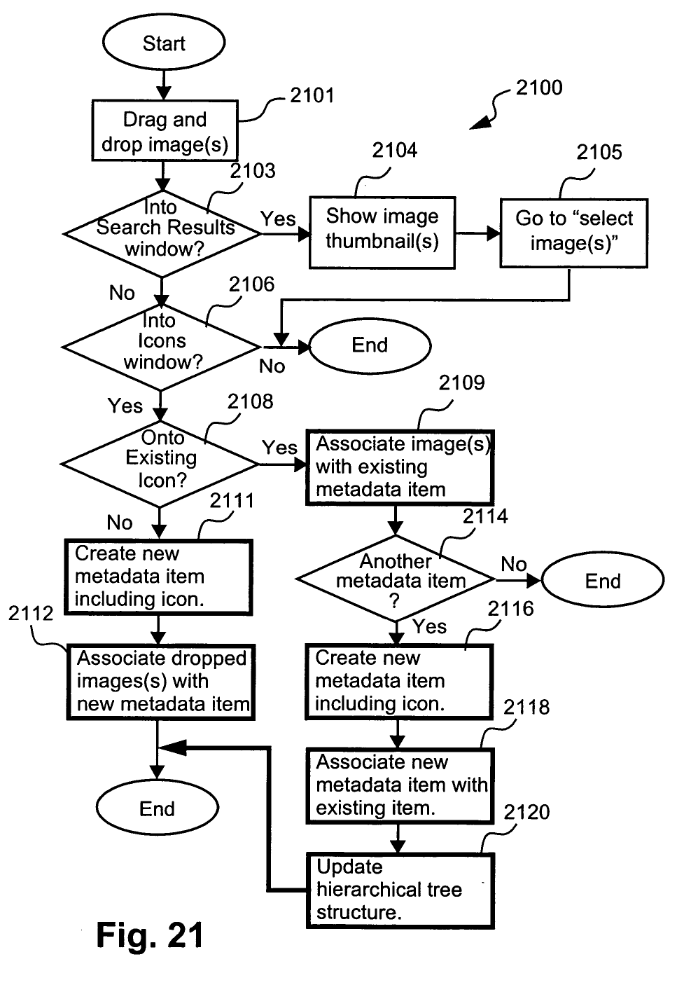

FIG. 21 is a flow diagram showing a further method 2100 of classifying one or more images in accordance with another arrangement. The method 2100 may be implemented as software resident on the hard disk drive 1810 and being controlled in its execution by the processor 1805. In the method 2100, the metadata-image associations may be represented by a hierarchical structure such as the hierarchical tree structure 805, as seen in FIG. 8(e). Alternatively, any other suitable means may be used to represent the metadata-image associations, such as a table. In either instance, representations of parent-child relationships between metadata items and particularly child icons may be generated by dragging and dropping an existing icon within the Icons window 101, as will be described in detail below. For example, the sub-node represented by the child icon 813 may be generated by dragging and dropping the image 106 of a “B” and the image 107 of a “C” onto the icon 817, if the images 106 and 107 already have an associated metadata item, “cons”. An example of the generation of such child icons will be described below.

The process of the method 2200 begins at step 2101, where a thumbnail (or iconic) representation of an image (i.e., an image file) may be selected, dragged and dropped in either of the windows 101 or 102, using the mouse 1803. At the next step 2103, if the image is dropped within the client area 104 of the search results window 103, then the method 2100 proceeds to step 2104. Otherwise, the method 2100 proceeds to step 2106.

At step 2104, the processor 1805 displays the thumbnail representation of the selected image within the window 103. Then at the next step 2105, the image dropped in the window 103 remains selected (i.e., highlighted as known in the relevant art), implying that further actions follow the selection of the image, as described above with reference to step 1205 of the method 1200. The method 2100 concludes after step 2105.

At step 2106, if the processor 1805 determines that the selected image has not been dropped within the client area of the Search Results window 103 or the Icons window 101, then the method 2100 concludes. Otherwise, if the selected image was dropped within the client area 102 of the Icons window 101, then the method 2100 proceeds to step 2108. At step 2108, if the image was dropped onto an icon already existing in the window 101, then the method proceeds to step 2109. Otherwise the method 2100 proceeds to step 2111.

At step 2111, the processor 1805 generates a new icon representing an item of metadata. Again, the item of metadata represented by the icon generated at step 2111 may be read from the file header of the dropped image, or the processor 1805 may read a reference, associated with the dropped image to an item of metadata stored in memory 1806. The metadata item generated at step 2111 may be initialised, as described above. At the next step 2112, the image dropped into the Icons window 101 is added to an image association list for the icon generated at step 2111 and a metadata-image association is added to a metadata item record corresponding to the icon.

At step 2109, a reference to the dropped image is added to an association list corresponding to the existing icon and the metadata item record of the existing icon is updated. At the next step 2114, if the processor 1805 determines that the dropped image has another item of metadata associated with the dropped image, other than the item of metadata represented by the existing icon, then the method 2100 proceeds to step 2116. Otherwise, the method 2100 concludes.

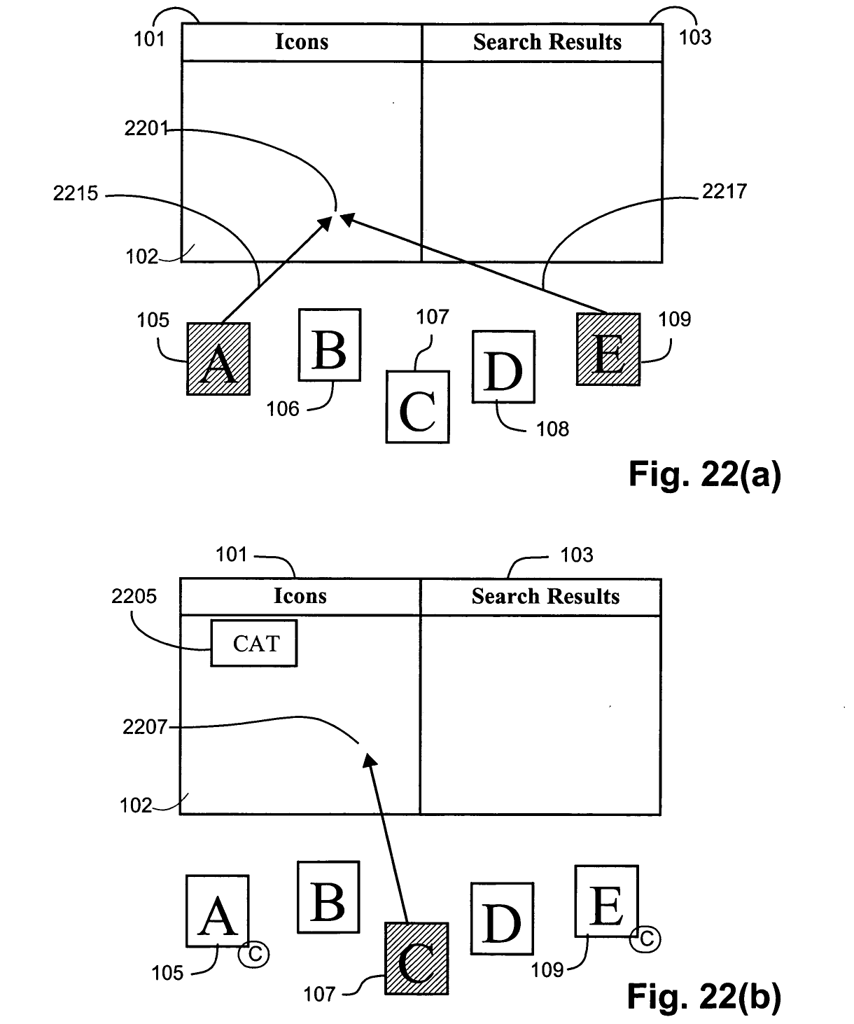

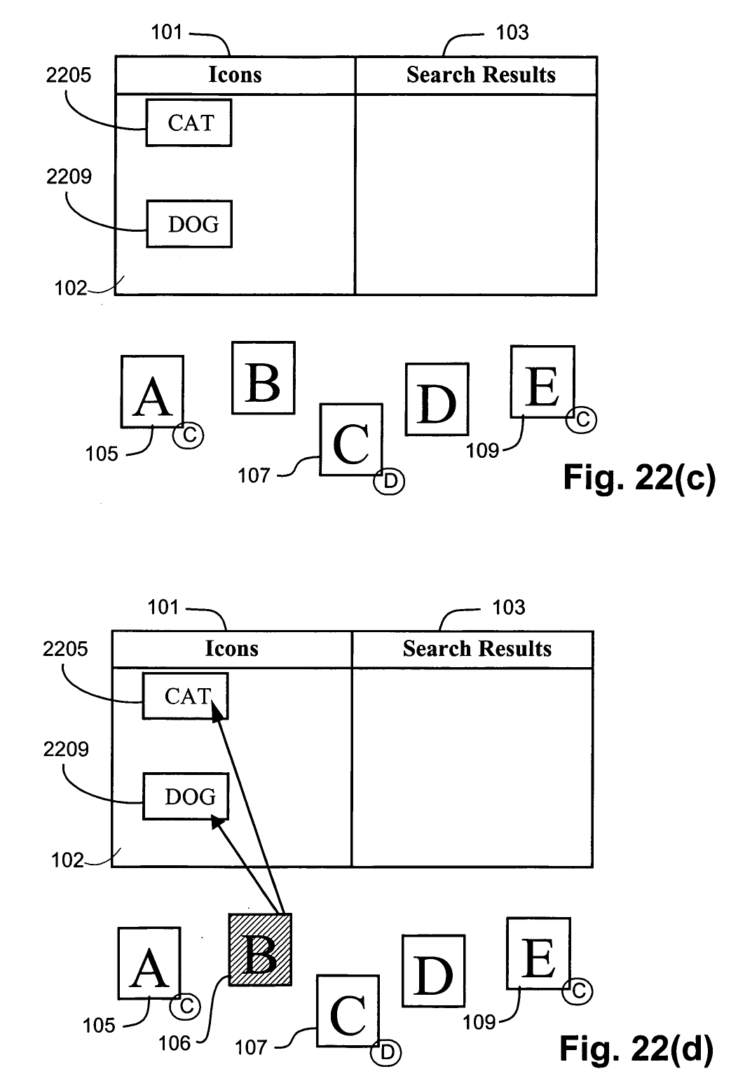

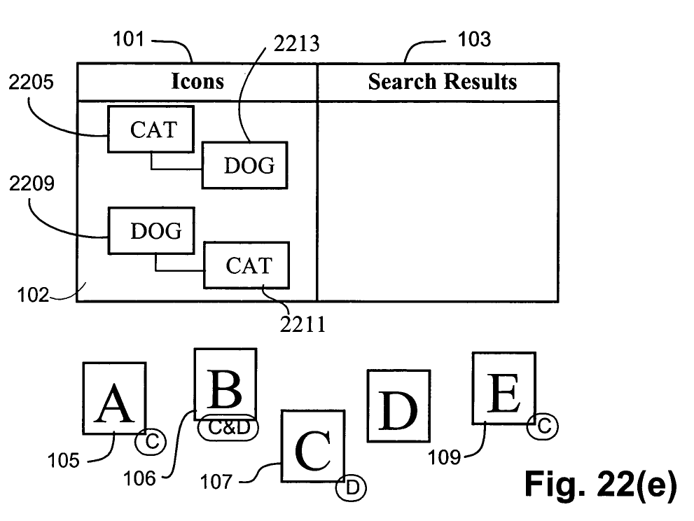

At step 2116, the processor 1805 generates a new icon representing the other item of metadata associated with the dropped image. Again, the item of metadata represented by the icon generated at step 2116 may be read from the file header of the dropped image. Alternatively, the processor 1805 may read a reference, associated with the dropped image to an item of metadata stored in memory 1806. At the next step 2118, a reference (i.e., metadata-image association) to the other item of metadata (i.e., represented by the icon generated at step 2116) is stored in the metadata item record corresponding to the existing icon. At the next step 2120, the icon generated at step 2116 is represented in the icons window 101 as a child of the existing icon represented in the icons window 101 and the method 2100 concludes. As example of the method 2100, FIG. 22(a) shows the images 105, 106, 107, 108 and 109. In accordance with this example, the images 105 and 109 contain a representation of a cat. The images 105 and 109 are selected and dragged to a point 2201 within the client area 102 of the icons window 101, as represented by the arrows 2215 and 2217 in FIG. 22(a) As a result, an icon 2205 shown in FIG. 22(b) and associated metadata item (not shown) is generated by the processor 1805 (i.e., as at step 2111 of the method 2100). The item of metadata represented by the icon 2205 may be read from the file headers of the images 105 and 109. Alternatively, the processor 1805 may read a reference, associated with the images 105 and 109, to an item of metadata stored in memory 1806. The metadata item generated for the selected images 105 and 109 may also be initialised to the word “CAT”, as described above. The images 103 and 109 are added to an image association list for the icon 2205 and a metadata-image association is added to a metadata item record corresponding to the icon 2205. As seen in FIG. 22(b), the icon 2205 has been labelled “CAT” to indicate that the images 105 and 109 contain a cat and are associated with the metadata item CAT.

Continuing the example, the image 107 contains a dog. The image 107 is selected and dragged to a point 2207 within the client area 102 of the icons window 101. As a result, an icon 2209 shown in FIG. 22(c) representing a metadata item is generated by the processor 1805. Again, the item of metadata represented by the icon 2209 may be read from the file header of the image 107, or from a reference, associated with the image 107, to an item of metadata stored in memory 1806. The metadata item associated with the selected image 107 may be initialised to the word “DOG”, as described above. The image 107 is added to an image association list for the icon 2209 and a metadata-image association is added to the metadata item record corresponding to the icon 2209. As seen in FIG. 22(c), the icon 2209 has been labelled “DOG” to indicate that the image 107 contains a dog and is associated with the metadata item DOG.

Continuing the present example, the image 106 contains a cat and a dog. The image may be classified by selecting the image 106 and dragging the image 106 into the client area 102 of the window 101, and dropping the image 106 on the existing icon 2205, as at step 2108 of the method 2101 of the method 2100. The image 106 is added to the image association list of the icon 2205 and a metadata-image association is added to the metadata item record corresponding to the icon 2205. Accordingly, the image 106 is associated with the item of metadata, “CAT”. The image may then be classified again by selecting the image 106 and dragging the image 106 into the client area 102 of the window 101, and dropping the image 106 on the existing icon 2209, as at step 2101 of the method 2100. The image 106 is foreign to the set of images associated with the icon 2209. Thus, the image 106 is added to the image association list of the icon 2209 and a metadata-image association is added to the metadata item record corresponding to the icon 2209. Further, as at step 2114 of the method 2100, the processor 1805 determines that the image 106 has a further associated metadata item, “CAT”, representing that the image contains a cat. As a result, the processor 1805 generates a new icon 2211 shown in FIG. 22(e) representing the other item of metadata (i.e., CAT) associated with the dropped image 106. A reference representing the fact that the item of metadata (i.e., CAT) is associated with the existing metadata item (i.e., DOG) represented by the icon 2209, is also stored in the metadata item record of the icon 2209. As seen in FIG. 22(e), the icon 2211 is represented in the icons window 101 as a child of the existing icon 2209 represented in the icons window 101. Further, the reference representing the fact that the item of metadata (i.e., CAT) is associated with the existing metadata item (i.e., DOG) results in the processor 1805 generating a still further icon 2213 representing the “DOG” metadata item. The icon 2213 is represented as a child of the existing icon 2205 represented in the icons window 101.

Accordingly, icons may be generated automatically based on the metadata-image associations between metadata items of images dropped within the client area 102 of the window 101.

Continuing the example of FIGS. 22(a) to 22(e), if the image 106 is then deleted by selecting the image 106 in a conventional manner and pressing the delete button on the keyboard 1802, for example, the reference to the image 106 is deleted from the image association lists of both the icons 2205 and 2209. Further, the metadata-image associations corresponding to the image 106 are deleted from the metadata item records corresponding to each of the icons 2205 and 2209. The icons 2211 and 2213 are also deleted from the Icons window 101 such that the Icons window 101 returns to the state that it was in, as shown in FIG. 22(d), where the Icons window 101 just contains the icons 2205 and 2209.

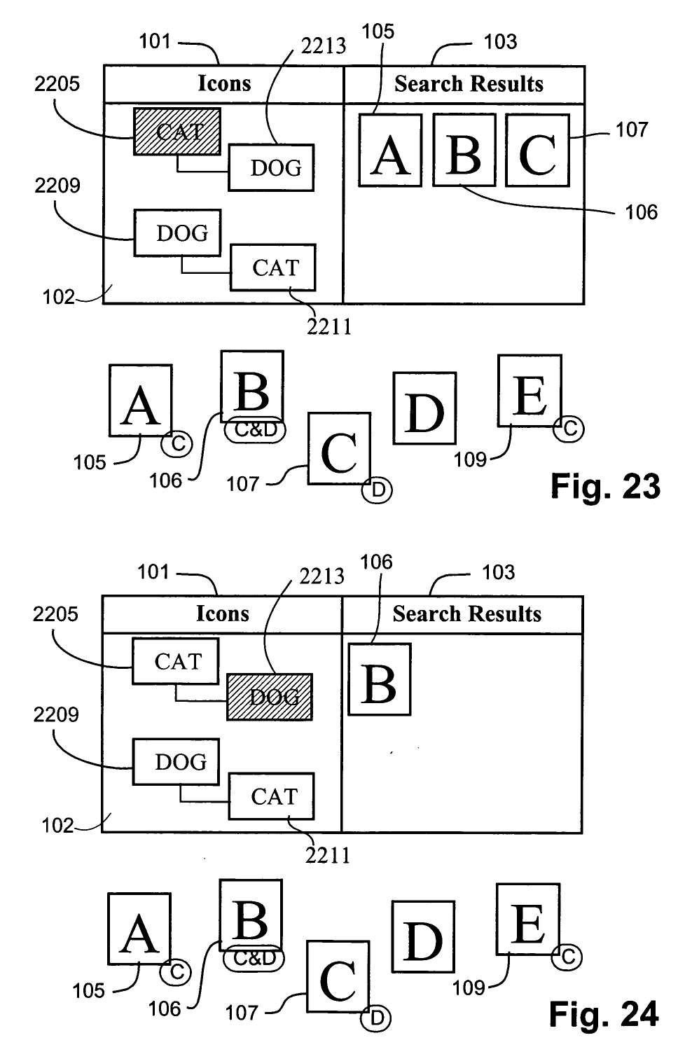

The icons 2205, 2213, 2209 and 2211, arranged in a hierarchical manner as shown in FIG. 22(e) and generated as described above, may be used to perform a simple forward search. FIG. 23 shows the icon 2205 selected and highlighted in a conventional manner (i.e., by shading), as at step 1502 of the method 1500. Selecting the icon 2205 results in the images 105, 106 and 109 associated with the icon 2205, being displayed in the Search Results window 103. As described above with reference to FIGS. 22(a) to 22(e), the images 105, 106 and 109 were previously classified as belonging to the icon 2205 and being associated with the metadata item, CAT, of the icon 205, since the images 105, 106 and 109 contain a cat. Accordingly, in response to the selection of the icon 2205, the processor 1805 generates a query to determine all images being associated with the metadata item “CAT” represented by the selected icon 2205. Based on the generated query, the processor 1805 determines that the images 105, 106 and 109 are associated with the icon 2205 and displays the images 105, 106 and 109 in the Search Results window 103.

Similarly, FIG. 24 shows the icon 2213 selected and highlighted in a conventional manner (i.e., by shading), as at step 1502 of the method 1500. Selecting the icon 2213 results in the image 106 associated with the icon 2213, being displayed in the Search Results window 103. As described above with reference to FIGS. 22(a) to 22(e), the image 106 was previously classified as belonging to the icon 2213 and the metadata items (i.e., “CAT” and “DOG”) of the icon 2213, since the image 106 contains a cat and a dog. Again, in response to the selection of the icon 2213, the processor 1805 generates a query to determine all images being associated with the metadata items “CAT” and “DOG” represented by the selected icon 2213. Based on the generated query, the processor 1805 determines that the image 106 is associated with the icon 2213 and displays the image 106 in the Search Results window 103.

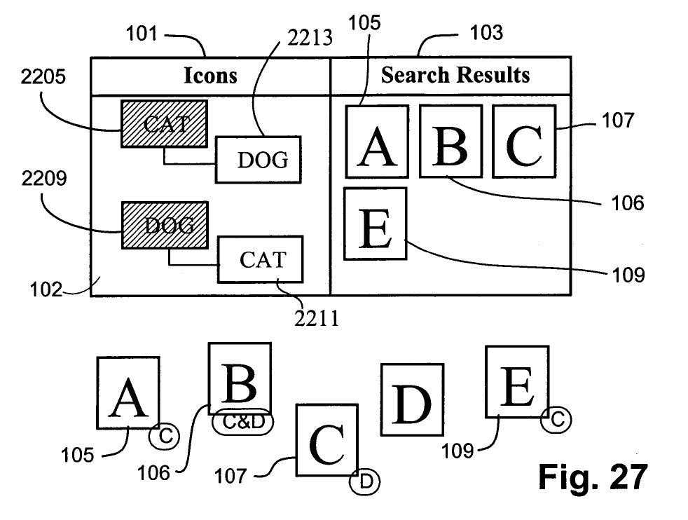

In still a further example, FIG. 27 shows the icons 2205 and 2209 selected and highlighted in a conventional manner (i.e., by shading). Selecting the icons 2205 and 2209 results in the images 105, 106, 107 and 109 which are each associated with either the icon 2205 OR the icon 2209, being displayed in the Search Results window 103. As described above with reference to FIGS. 22(a) to 22(e), the images 105, 106 and 109 were previously classified as being associated with the icon 2205 and the metadata item, CAT, of the icon 2205, since the images 105, 106 and 109 contain a cat. Further, the images 106 and 107 were previously classified as being associated with the icon 2209 and the metadata item, DOG, of the icon 2209, since the images 106 and 107 contain a dog. Again, in response to the selection of the icons 2205 and 2209, the processor 1805 generates a query to determine all images being associated with the metadata item “CAT” represented by the selected icon 2205 “OR” the metadata item “DOG” represented by the selected icon 2209. Based on the generated query, the processor 1805 determines that the images 105, 106, 107 and 109 are associated with either the icon 2205 or the icon 2209 and displays the images 105, 106, 107 and 109 in the Search Results window 103.

Accordingly, selection of multiple metadata icons (e.g., 2205) and particularly multiple child icons (e.g., 2213) results in the processor 1805 generating some sophisticated queries in order to enable a user to a user to quickly and easily determine which items of metadata are associated with a particular image or set of images in a visual manner.

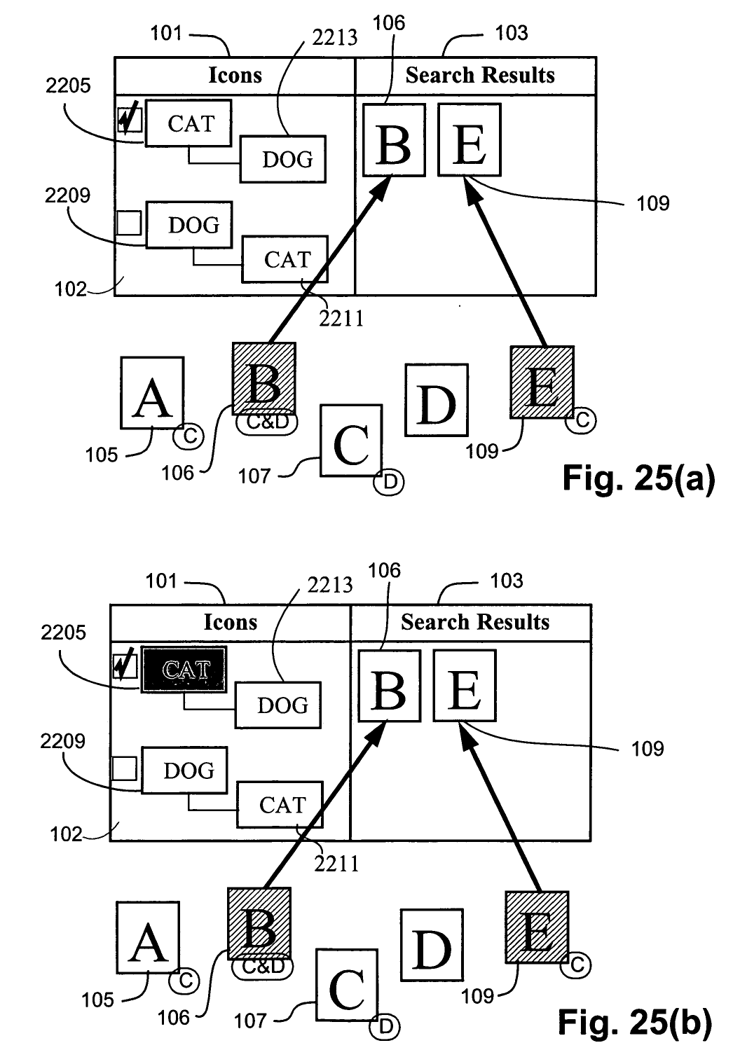

The icons 2205, 2213, 2209 and 2211 arranged in a hierarchical manner as shown in FIG. 22(e) and generated as described above, may also be used to perform an inverse search. In this instance, tick boxes 2502 and 2505 may be positioned next to each of the parent icons 2205 and 2209, respectively, as shown in FIG. 25(a). To perform an inverse search, the images (e.g., the images 106 and 109) may be dragged into the client area 102 of the Search Results window 103. As a result, the tick box 2502 positioned next to the icon 2205, is ticked, as shown in FIG. 25(a), to indicate that the metadata icon 2205 is associated with each of the images 106 and 109 since each of the images contains a cat and are associated with the metadata item, CAT. However, the tick box 2505 next to the icon 2505 is not ticked since the image 109 does not contain a dog and does not have an associated metadata item, DOG. Therefore, the tick boxes 2502 and 2505 indicate the intersection of the two images 105 and 109 in that both of the images 105 and 109 contain a cat.

In an alternative arrangement, as well as the tick box 2502 being ticked to indicate the intersection of the two images 105 and 106, the icon 2505 may be highlighted in a conventional manner, as shown in FIG. 25(b), to indicate that both of the images are associated with the metadata item, CAT. In this instance, the icon 2209 may also be highlighted, to slightly lesser degree (i.e., having a lighter shading), to indicate that at least one of the images 105 contains a dog and is associated with the item of metadata, DOG.

Again, inverse searching in the manner described above allows a user to quickly and easily determine which items of metadata are associated with a particular image or set of images in a visual manner.

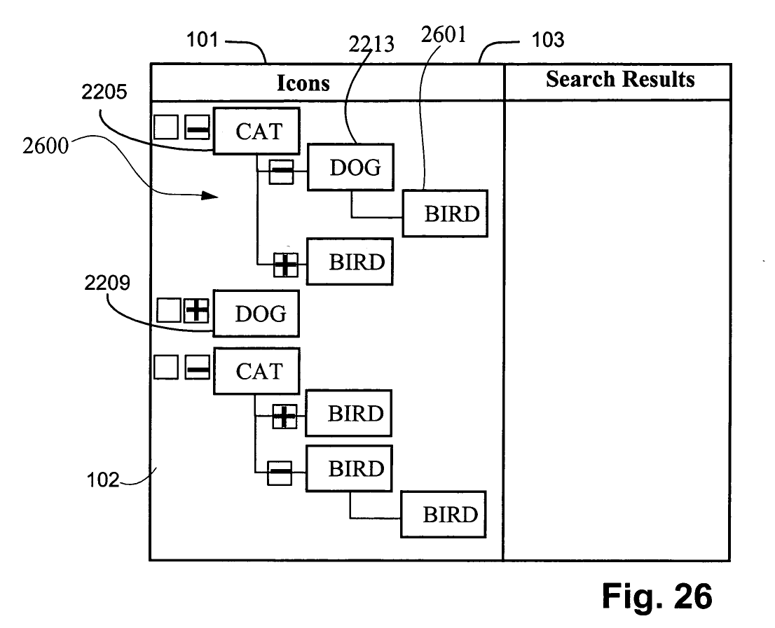

As described above, the above methods allow icons to be generated automatically based on the association between metadata items of images dropped within the client area 102 of the window 101. If a particular image is associated with a large number of metadata items, a large number of associated metadata icons and particularly child icons may be generated. For example, the image 106 described above was classified by dropping the image 106 on the existing icon 2209. This resulted in the generation of the child icon 2213. A further image (not shown) containing a bird, for example, and being associated with the metadata item “BIRD”, may then be classified by dropping the image on the metadata item 2213. As a result, a further icon 2601 representing the metadata item, BIRD, may be generated and represented as a child icon of the icon 2213, as shown by a metadata icon tree structure 2600 of FIG. 26.

In order to enable a user to quickly and easily navigate a hierarchical metadata icon tree structure such as the structure 2600, and to determine which items of metadata are associated with a particular image or set of images, the metadata tree structure 2600 contains a number of conventional expand icons (e.g, 2603 and 2605). If a branch of the tree structure 2600 includes an expand icon such as the expand icon 2603, then the metadata icon next to the expand icon includes one or more child metadata icons. For example, the expand icon 2603 next to the metadata icon 2205 indicates that the icon 2205 has child icons 2213 and 2607. The expand icons have a ‘−’ sign (e.g., the icon 2603) within the icon to indicate that the associated icon 2205 is open and displaying child icons. Further, the expand icons have a ‘+’ sign (e.g., the icon 2605) within the icon to indicate that the associated metadata icon 2607 is closed and not displaying child icons.

The aforementioned preferred method(s) comprise a particular control flow. There are many other variants of the preferred method(s), which use different control flows without departing the spirit or scope of the invention. Furthermore one or more of the steps of the preferred method(s) may be performed in parallel rather sequentially.

The foregoing describes only some embodiments of the present invention, and modifications and/or changes can be made thereto without departing from the scope and spirit of the invention, the embodiments being illustrative and not restrictive. For example, the methods described above can also be implemented as an interface embedded within an existing application or as a standalone application. Such applications can be executed either on an individual computer (e.g. the computer 1800) or on a number of computers (not shown) across a network (e.g. the network 1820).

The claims defining the invention are as follows:

1. A method of classifying one or more images, said method comprising the steps of:
selecting an iconic representation of at least one image displayed on a graphical user interface;
moving said iconic representation to a target position within an area defined by said graphical user interface, according to a classification of said image; and
determining an association between said at least one image and at least one predetermined metadata item representing said classification, in response to said iconic representation being positioned at said target position.

2. A method according to claim 1, further comprising the steps of:
generating an iconic representation of said metadata item; and
displaying said metadata representation on said graphical user interface.

3. A method according to claim 2, further comprising the steps of:
selecting at least one further iconic representation of at least one further image displayed on said graphical user interface;
moving said iconic representation to a position defined by said displayed metadata representation; and
creating an association between said further image and said at least one metadata item.

4. A method according to claim 2, wherein the iconic representations of the metadata items are arranged according to a hierarchical structure.

5. A method according to claim 4, wherein said hierarchical structure is updated based on metadata items associated with at least one of said images.

6. A method according to claim 1, further comprising the step of storing said association between said at least one image and said at least one metadata item.

7. A method of classifying one or more images, said method comprising the steps of:
selecting an iconic representation of at least one image, displayed on a graphical user interface;
moving said iconic representation to a target position within an area defined by said graphical user interface, according to a classification of said image;
creating an association between said at least one image and at least one metadata item, in response to said iconic representation being positioned at said target position; and
generating an iconic representation of said at least one metadata item representing said classification.

8. A method according to claim 7, further comprising the step of displaying said metadata representation on said graphical user interface.

9. A method according to claim 8, further comprising the steps of:
selecting at least one further iconic representation of at least one further image, displayed on said graphical user interface;
moving said iconic representation to a position defined by said displayed metadata representation; and
creating an association between said further image and said at least one metadata item.

10. A method according to claim 8, wherein the iconic representations of the metadata items are arranged according to a hierarchical structure.

11. A method according to claim 10, wherein said hierarchical structure is updated based on metadata items associated with at least one of said images.

12. A method of searching for at least one image from a plurality of images, said method comprising the steps of:
selecting an iconic representation of at least one metadata item displayed on a graphical user interface;
determining an association between said at least one metadata item and said at least one image; and
generating an iconic representation of said at least one image, said iconic representation of said at least one image being adapted for display on said graphical user interface.

13. A method according to claim 12, further comprising the step of displaying said iconic representation of said at least one image on said graphical user interface.

14. A method according to claim 12, further comprising the steps of:
selecting at least one further iconic representation of at least one further metadata item displayed on said graphical user interface;
determining an association between said at least one further metadata item and at least one further image; and
generating an iconic representation of said at least one further image for display on said graphical user interface.

15. A method according to claim 13, wherein the iconic representations of the metadata items are arranged according to a hierarchical structure.

16. A method according to claim 15, wherein said hierarchical structure is updated based on metadata items associated with at least one of said images.

17. A graphical user interface for representing classification relationships between one or more images and one or more metadata items, said graphical user interface comprising:
selection means for moving at least one iconic representation of at least one of said images displayed on said graphical user interface, to a target position within an area defined by said graphical user interface, according to a classification of said image; and
at least one portion for displaying an iconic representation of a metadata item representing said classification, said metadata data item being generated and displayed in response to said at least one iconic representation being positioned at said target position.

18. A graphical user interface according to claim 17, further comprising:
a further selection means for selecting said iconic representation of said at least one metadata item displayed on a graphical user interface; and
at least one further portion for displaying at least said iconic representation of said at least one image in response to said selection of said iconic representation of said at least one metadata item.

19. A graphical user interface according to claim 18, wherein said further portion displays any further iconic representations of said one or more images, said further iconic representations being generated depending on determined associations between said one or more images and any other metadata items represented in said at least one portion.

20. A graphical user interface according to claim 18, wherein the iconic representations of the metadata items are arranged according to a hierarchical structure.

21. A graphical user interface according to claim 20, wherein said hierarchical structure is updated based on metadata items associated with at least one of said images.

22. An apparatus for classifying one or more images, said apparatus comprising:
selection means for selecting an iconic representation of at least one image displayed on a graphical user interface and moving said iconic representation to a target position within an area defined by said graphical user interface, according to a classification of said image; and
determining means for determining an association between said at least one image and at least one predetermined metadata item representing said classification, in response to said iconic representation being positioned at said target position.

23. An apparatus for classifying one or more images, said apparatus comprising:
selection means for selecting an iconic representation of at least one image, displayed on a graphical user interface and moving said iconic representation to a target position within an area defined by said graphical user interface, according to a classification of said image;
creation means for creating an association between said at least one image and at least one metadata item, in response to said iconic representation being positioned at said target position; and
generation means for generating an iconic representation of said at least one metadata item representing said classification.

24. An apparatus for searching for at least one image from a plurality of images, said apparatus comprising:
selection means for selecting an iconic representation of at least one metadata item displayed on a graphical user interface;
determining means for determining an association between said at least one metadata item and said at least one image; and
generation means for generating an iconic representation of said at least one image, said iconic representation of said at least one image being adapted for display on said graphical user interface.

25. A computer program product comprising a computer readable medium having recorded thereon a computer program for classifying one or more images, said program comprising:
code for selecting an iconic representation of at least one image displayed on a graphical user interface;
code for moving said iconic representation to a target position within an area defined by said graphical user interface, according to a classification of said image; and
code for determining an association between said at least one image and at least one predetermined metadata item representing said classification, in response to said iconic representation being positioned at said target position.

26. A computer program product comprising a computer readable medium having recorded thereon a computer program for classifying one or more images, said program comprising:
code for selecting an iconic representation of at least one image, displayed on a graphical user interface;
code for moving said iconic representation to a target position within an area defined by said graphical user interface, according to a classification of said image;
code for creating an association between said at least one image and at least one metadata item, in response to said iconic representation being positioned at said target position; and
code for generating an iconic representation of said at least one metadata item representing said classification.

27. A computer program product comprising a computer readable medium having recorded thereon a computer program for searching for at least one image from a plurality of images, said program comprising:
code for selecting an iconic representation of at least one metadata item displayed on a graphical user interface;
code for determining an association between said at least one metadata item and said at least one image; and
code for generating an iconic representation of said at least one image, said iconic representation of said at least one image being adapted for display on said graphical user interface.

28. A method of searching for at least one image from a plurality of images, said method comprising the steps of:
selecting a plurality of iconic representations of metadata items displayed on a graphical user interface, said iconic representations being arranged according to a hierarchical structure;
generating a query based on said selection of said plurality of iconic representations;
determining at least one association between one or more metadata items represented by the selected iconic representations and said at least one image based on said query; and
generating an iconic representation of said at least one image, said iconic representation of said at least one image being adapted for display on said graphical user interface.

29. An apparatus for searching for at least one image from a plurality of images, said apparatus comprising:
selection means for selecting a plurality of iconic representations of metadata items displayed on a graphical user interface, said iconic representations being arranged according to a hierarchical structure;
query generation means for generating a query based on said selection of said plurality of iconic representations;
determining means for determining at least one association between one or more metadata items represented by the selected iconic representations and said at least one image based on said query; and
iconic generation means for generating an iconic representation of said at least one image, said iconic representation of said at least one image being adapted for display on said graphical user interface.

30. A computer program product comprising a computer readable medium having recorded thereon a computer program for searching for at least one image from a plurality of images, said program comprising:
code for selecting a plurality of iconic representations of metadata items displayed on a graphical user interface, said iconic representations being arranged according to a hierarchical structure;
code for generating a query based on said selection of said plurality of iconic representations;
code for determining at least one association between one or more metadata items represented by the selected iconic representations and said at least one image based on said query; and
code for generating an iconic representation of said at least one image, said iconic representation of said at least one image being adapted for display on said graphical user interface.
